(19) United States
(12) Patent Application Publication
(10) Pub. No.: US 2026/0359308 A1
(43) Pub. Date: Nov. 12, 2026

(54) HETEROGENEOUS FEATURE INTERACTIONS WITH TRANSFORMERS

(71) Applicant: Google LLC, Mountain View, CA (US)

(72) Inventors: Huan Gui, Mountain View, CA (US); Lichan Hong, Los Altos, CA (US); Ed Huai-hsin Chi, Mountain View, CA (US); Taibai Xu, Mountain View, CA (US); Ruoxi Wang, Palo Alto, CA (US); Ke Yin, Santa Clara, CA (US); Maciej Kula, Mountain View, CA (US); Long Jin, Sunnyvale, CA (US)

(21) Appl. No.: 19/487,900

(22) PCT Filed: May 21, 2024
(86) PCT No.: PCT/US2024/030365

§ 371 Date: Nov. 25, 2025

Related U.S. Application Data
(60) Provisional application No. 63/504,515, filed on May 26, 2023.

(51) Int. Cl. G06F 16/2457; G06F 16/22

(52) U.S. Cl. CPC G06F 16/24578; G06F 16/2237

(57) ABSTRACT

A computing system receives information indicative of interactions between a user and previously recommended items. The computing system transforms the information into a feature embeddings list. The computing system applies a heterogeneous self-attention model to the feature embeddings list. The heterogeneous self-attention model learns individual query, key, and value projection matrices for each feature embedding. The computing system generates a unique transformation matrix for each pair of feature embeddings. The computing system concatenates the individual query, key, and value projection matrices into a single concatenated matrix and generates a full projection matrix by at least applying a linear transformation to the single concatenated matrix. The computing system applies a heterogeneous interaction transformer model to the feature embeddings list to generate a weighted feature embeddings list including weighted task embeddings. The computing system generates a set of recommended items based on applying a projection function to the weighted task embeddings.

### CROSS-REFERENCE TO RELATED APPLICATION

This application claims the benefit of U.S. Provisional Patent Application No. 63/504,515, filed May 26, 2023, which is incorporated by reference herein in its entirety.

### BACKGROUND

Web-scale recommender systems are a type of machine learning system that provides personalized recommendations for large volumes of users and items. These systems are important in many industries such as e-commerce, social media, and entertainment. However, one of the most significant challenges in designing effective recommender systems is learning the complex interactions between user and item features, which are usually high-dimensional and sparse. The interactions between features are important because they capture the relationships between different features, such as the synergistic or antagonistic effects between them. Nevertheless, learning these feature interactions is a difficult task, as it requires modeling the joint distribution of all the features, which can be computationally intensive and prone to overfitting. Currently, a transformer-based neural network architecture may utilize attention layers, as self-attention can automatically capture feature interactions between different parts of an input sequence. However, when applying the transformer architecture to web-scale recommender systems, the transformer architecture fails to capture heterogeneous feature interactions in the self-attention layer.

### SUMMARY

In general, techniques of this disclosure are directed to techniques for applying a heterogeneous feature interaction transformer model for feature interaction learning in recommender systems. A vanilla transformer model, also known as a transformer network, is a type of deep learning model used primarily in natural language processing tasks such as language translation, language modeling, and text classification. Vanilla transformer models are based on a self-attention mechanism, which allows the model to weigh the importance of different parts of an input sequence when making predictions. The model consists of an encoder and a decoder, both of which are made up of multiple layers of self-attention and feedforward neural networks. During training, the model learns to predict the next token in a sequence or generate a new sequence based on an input sequence. However, vanilla transformer models typically only capture homogeneous feature interactions between words or tokens in the sequence. In recommender systems, non-textual features are common, in which heterogeneous feature interactions may need to be captured. As such, the vanilla transformer model is not as applicable or ideal for recommender systems. The techniques of this disclosure enable capture of heterogeneous feature interactions using a different transformer model design that includes a heterogeneous self-attention layer. The heterogeneous interaction transformer (also referred to herein as “heterogeneous feature interaction transformer model”) described in this disclosure may be feature semantic aware, comply with the stringent latency requirements of web-scale applications, enable fast inference for online deployment, and provide more efficient and accurate recommendations for a recommender system.

In one example, the disclosure is directed to a method comprising receiving, by a computing system, information indicative of interactions between a user and a plurality of previously recommended items, wherein the information includes one or more of encoded categorical features of one or more user-item pairs, encoded dense scalar features of one or more user-item pairs, and encoded task embeddings; transforming, by the computing system, one or more of the encoded categorical features, the encoded dense scalar features, and the encoded task embeddings into a feature embeddings list, wherein the feature embeddings list includes pairs of feature embeddings; applying, by the computing system, a heterogeneous self-attention model comprising a heterogeneous multi-head self-attention layer to the feature embeddings list, wherein the heterogeneous self-attention model learns individual query, key, and value projection matrices for each individual feature embedding in each pair of feature embeddings; generating, by the computing system, a unique transformation matrix for each pair of feature embeddings, wherein the unique transformation matrix transforms each individual feature embedding into a shared space; concatenating, by the computing system, the individual query, key, and value projection matrices for each individual feature embedding into a single concatenated matrix; generating, by the computing system, a full projection matrix by at least applying a linear transformation to the single concatenated matrix; applying, by the computing system, and using the full projection matrix, a heterogeneous interaction transformer model to the feature embeddings list and the encoded task embeddings, wherein the feature embeddings list is transformed into a plurality of composite features, wherein the heterogeneous interaction transformer model computes attention scores between the encoded task embeddings and the plurality of composite features, and wherein the attention scores are used to generate a weighted feature embeddings list including weighted categorical features, weighted dense scalar features, and weighted task embeddings; generating, by the computing system, a set of recommended items based on applying a projection function to the weighted task embeddings, wherein the projection function transforms the weighted task embeddings into the set of recommended items; and storing, by the computing system, in a memory, data indicative of the set of recommended items.

In another example, the disclosure is directed to a computing system comprising one or more processors; and one or more storage devices that store instructions, wherein the instructions, when executed by the one or more processors, cause the one or more processors to receive information indicative of interactions between a user and a plurality of previously recommended items, wherein the information includes one or more of encoded categorical features of one or more user-item pairs, encoded dense scalar features of one or more user-item pairs, and encoded task embeddings; transform one or more of the encoded categorical features, the encoded dense scalar features, and the encoded task embeddings into a feature embeddings list, wherein the feature embeddings list includes pairs of feature embeddings; apply a heterogeneous self-attention model comprising a heterogeneous multi-head self-attention layer to the feature embeddings list, wherein the heterogeneous self-attention model learns individual query, key, and value projection matrices for each individual feature embedding in each pair of feature embeddings; generate a unique transformation matrix for each pair of feature embeddings, wherein the unique transformation matrix transforms each individual feature embedding into a shared space; concatenate the individual query, key, and value projection matrices for each individual feature embedding into a single concatenated matrix; generate a full projection matrix by at least applying a linear transformation to the single concatenated matrix; apply, using the full projection matrix, a heterogeneous interaction transformer model to the feature embeddings list and the encoded task embeddings, wherein the feature embeddings list is transformed into a plurality of composite features, wherein the heterogeneous interaction transformer model computes attention scores between the encoded task embeddings and the plurality of composite features, and wherein the attention scores are used to generate a weighted feature embeddings list including weighted categorical features, weighted dense scalar features, and weighted task embeddings; generate a set of recommended items based on applying a projection function to the weighted task embeddings, wherein the projection function transforms the weighted task embeddings into the set of recommended items; and store data indicative of the set of recommended items in the one or more storage devices.

In another example, the disclosure is directed to a non-transitory computer-readable storage medium encoded with instructions that, when executed by one or more processors, cause one or more processors to receive information indicative of interactions between a user and a plurality of previously recommended items, wherein the information includes one or more of encoded categorical features of one or more user-item pairs, encoded dense scalar features of one or more user-item pairs, and encoded task embeddings; transform one or more of the encoded categorical features, the encoded dense scalar features, and the encoded task embeddings into a feature embeddings list, wherein the feature embeddings list includes pairs of feature embeddings; apply a heterogeneous self-attention model comprising a heterogeneous multi-head self-attention layer to the feature embeddings list, wherein the heterogeneous self-attention model learns individual query, key, and value projection matrices for each individual feature embedding in each pair of feature embeddings; generate a unique transformation matrix for each pair of feature embeddings, wherein the unique transformation matrix transforms each individual feature embedding into a shared space; concatenate the individual query, key, and value projection matrices for each individual feature embedding into a single concatenated matrix; generate a full projection matrix by at least applying a linear transformation to the single concatenated matrix; apply, using the full projection matrix, a heterogeneous interaction transformer model to the feature embeddings list and the encoded task embeddings, wherein the feature embeddings list is transformed into a plurality of composite features, wherein the heterogeneous interaction transformer model computes attention scores between the encoded task embeddings and the plurality of composite features, and wherein the attention scores are used to generate a weighted feature embeddings list including weighted categorical features, weighted dense scalar features, and weighted task embeddings; generate a set of recommended items based on applying a projection function to the weighted task embeddings, wherein the projection function transforms the weighted task embeddings into the set of recommended items; and store data indicative of the set of recommended items.

In another example, the disclosure is directed to a computer program product for a recommender system, the computer program product comprising at least one non-transitory computer-readable medium including one or more instructions that, when executed by at least one processor, cause the at least one processor to receive information indicative of interactions between a user and a plurality of previously recommended items, wherein the information includes one or more of encoded categorical features of one or more user-item pairs, encoded dense scalar features of one or more user-item pairs, and encoded task embeddings; transform one or more of the encoded categorical features, the encoded dense scalar features, and the encoded task embeddings into a feature embeddings list, wherein the feature embeddings list includes pairs of feature embeddings; apply a heterogeneous self-attention model comprising a heterogeneous multi-head self-attention layer to the feature embeddings list, wherein the heterogeneous self-attention model learns individual query, key, and value projection matrices for each individual feature embedding in each pair of feature embeddings; generate a unique transformation matrix for each pair of feature embeddings, wherein the unique transformation matrix transforms each individual feature embedding into a shared space; concatenate the individual query, key, and value projection matrices for each individual feature embedding into a single concatenated matrix; generate a full projection matrix by at least applying a linear transformation to the single concatenated matrix; apply, using the full projection matrix, a heterogeneous interaction transformer model to the feature embeddings list and the encoded task embeddings, wherein the feature embeddings list is transformed into a plurality of composite features, wherein the heterogeneous interaction transformer model computes attention scores between the encoded task embeddings and the plurality of composite features, and wherein the attention scores are used to generate a weighted feature embeddings list including weighted categorical features, weighted dense scalar features, and weighted task embeddings; generate a set of recommended items based on applying a projection function to the weighted task embeddings, wherein the projection function transforms the weighted task embeddings into the set of recommended items; and store data indicative of the set of recommended items.

The details of one or more examples of the disclosure are set forth in the accompanying drawings and the description below. Other features, objects, and advantages of the disclosure will be apparent from the description and drawings, and from the claims.

### BRIEF DESCRIPTION OF THE FIGURES

FIG. 1 is a conceptual diagram illustrating an example computing system and GUI for providing recommendations to a user computing device, in accordance with one or more techniques of this disclosure.

FIG. 2 is a block diagram illustrating another example computing system configured to apply a machine learning module for providing recommendations to a user computing device, in accordance with one or more techniques of this disclosure.

FIG. 3 is a conceptual diagram illustrating a data preprocessing module for heterogeneous feature interaction learning, in accordance with one or more techniques of this disclosure.

FIG. 4 is a conceptual diagram illustrating a machine learning module for heterogeneous feature interaction learning, in accordance with one or more techniques of this disclosure.

FIG. 5 is a flowchart illustrating an example operation for applying a heterogeneous feature interaction transformer model, in accordance with one or more techniques of this disclosure.

### DETAILED DESCRIPTION

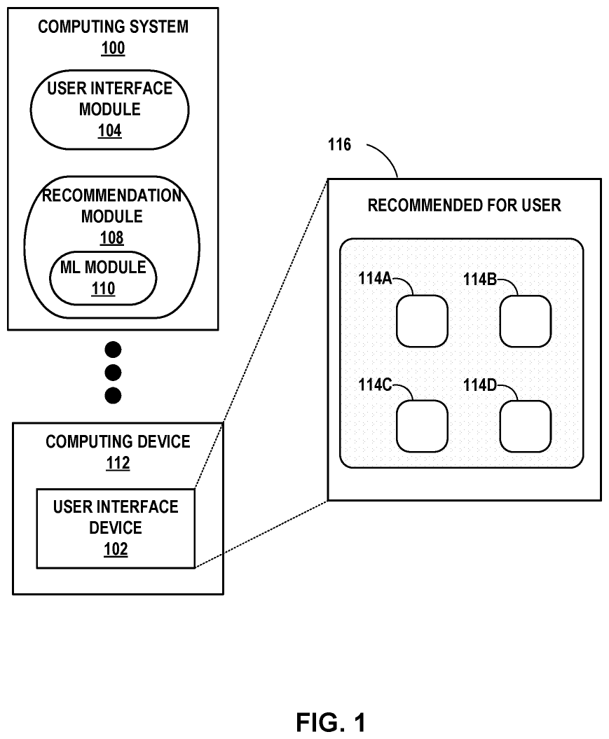

FIG. 1 is a conceptual diagram illustrating an example computing system and GUI for providing recommendations to a user computing device, in accordance with one or more techniques of this disclosure. Computing system 100 may be implemented on computing device 112. While not shown in the example of FIG. 1, computing system 100 may be implemented on a plurality of computing devices that may include, but are not limited to, portable, mobile, or other devices, such as mobile phones (including smartphones), laptop computers, desktop computers, tablet computers, smart television platforms, server computers, mainframes, etc. In some examples, computing system 100 may represent a cloud computing system that provides one or more services via the network. That is, in some examples, computing system 100 may be a distributed computing system.

Computing system 100 may communicate with or be implemented on computing device 112 via a network. The network may include any public or private communication network, such as a cellular network, Wi-Fi network, a direct cell-to-satellite communication network, or other type of network for transmitting data between computing system 100 and computing device 112. In some examples, the network may represent one or more packet switched networks, such as the Internet. Computing device 112 may send and receive data to and from computing system 100 across the network using any suitable communication techniques. For example, computing system 100 and computing device 112 may each be operatively coupled to the network using respective network links. The network may include network hubs, network switches, network routers, etc., that are operatively inter-coupled thereby providing for the exchange of information between computing device 112 and computing system 100. In some examples, network links of the network may be Ethernet, ATM or other network connections. Such connections may include wireless and/or wired connections.

As shown in the example of FIG. 1, computing device 112 includes one or more user interface (UI) devices (“UI device 102”). UI device 102 of computing device 112 may be configured to function as an input device and/or an output device for computing device 112. UI device 102 may be implemented using various technologies. For instance, UI device 102 may be configured to receive input from a user of computing device 112 through tactile, audio, and/or video feedback. Examples of input devices include a presence-sensitive display, a presence-sensitive or touch-sensitive input device, a mouse, a keyboard, a voice responsive system, video camera, microphone or any other type of device for detecting a command from a user of computing device 112. In some examples, a presence-sensitive display includes a touch-sensitive or presence-sensitive input screen, such as a resistive touchscreen, a surface acoustic wave touchscreen, a capacitive touchscreen, a projective capacitance touchscreen, a pressure sensitive screen, an acoustic pulse recognition touchscreen, or another presence-sensitive technology. That is, UI device 102 of computing device 112 may include a presence-sensitive device that may receive tactile input from a user of computing device 112. UI device 102 may receive indications of the tactile input by detecting one or more gestures from the user (e.g., when the user touches or points to one or more locations of UI device 102 with a finger or a stylus pen).

UI device 102 may additionally or alternatively be configured to function as an output device by providing output to a user of computing device 112 using tactile, audio, or video stimuli. Examples of output devices include a sound card, a video graphics adapter card, or any of one or more display devices, such as a liquid crystal display (LCD), dot matrix display, light emitting diode (LED) display, microLED, miniLED, organic light-emitting diode (OLED) display, e-ink, or similar monochrome or color display capable of outputting visible information to a user of computing device 112. Additional examples of an output device include a speaker, a haptic device, or other device that can generate intelligible output to a user. For instance, UI device 102 may present output to a user of computing device 112 as a graphical user interface that may be associated with functionality provided by computing device 112. In this way, UI device 102 may present various user interfaces of applications executing at or accessible by computing device 112 (e.g., an electronic message application, an Internet browser application, etc.). A user of computing device 112 may interact with a respective user interface of an application to cause computing device 112 to perform operations relating to a function.

In some examples, UI device 102 of computing device 112 may detect two-dimensional and/or three-dimensional gestures as input from a user of computing device 112. For instance, a sensor of UI device 102 may detect the user's movement (e.g., moving a hand, an arm, a pen, a stylus, etc.) within a threshold distance of the sensor of UI device 102. UI device 102 may determine a two- or three-dimensional vector representation of the movement and correlate the vector representation to a gesture input (e.g., a hand-wave, a pinch, a clap, a pen stroke, etc.) that has multiple dimensions. In other words, UI device 102 may, in some examples, detect a multi-dimension gesture without requiring the user to gesture at or near a screen or surface at which UI device 102 outputs information for display. Instead, UI device 102 may detect a multi-dimensional gesture performed at or near a sensor which may or may not be located near the screen or surface at which UI device 102 outputs information for display.

In the example of FIG. 1, computing system 100 includes user interface (UI) module 104. Module 104 may perform operations described herein using hardware, software, firmware, or a mixture thereof residing in and/or executing at computing system 100. Computing system 100 may execute module 104 with one processor or with multiple processors. In some examples, computing system 100 may execute module 104 as a virtual machine executing on underlying hardware. Module 104 may execute as one or more services of an operating system or computing platform or may execute as one or more executable programs at an application layer of a computing platform.

UI module 104, as shown in the example of FIG. 1, may be operable by computing system 100 to perform one or more functions, such as receive input and send indications of such input to other components associated with computing system 100. UI module 104 may also receive data from components associated with computing system 100. Using the data received, UI module 104 may cause other components associated with computing system 100, such as UI device 102, to provide output based on the data. For instance, UI module 104 may send data to UI device 102 of computing device 112 to display a GUI.

In general, a first user of computing device 112 may use a platform to view recommendations generated by computing system 100. In one example, a set of recommendations may be presented to the first user of computing device 112 in an online application store. For example, computing system 100 may support or be in communication with an online application store that may offer applications for download or purchase to the user of computing device 112. The user may interact with computing device 112 via UI device 102 to perform various functions. For example, the user may cause computing device 112 to execute an application that presents an online application store to the user via UI device 102. In one example, the user may execute a web browser and navigate to a web-based online application store. In another example, the user may execute an application that includes online application store functionality. The online application store may allow the user to browse, search, select, purchase, download, and install various applications on computing device 112. In some examples, computing system 100 may host the online application store. In these examples, communications modules of computing system 100 may receive data from computing device 112 including application descriptions, search results, and the content of one or more applications the user selects to download and/or install on computing device 112 via a network.

UI module 104 may generate a user interface that may be displayed a user of computing device 112 via GUI 116 of UI device 102 in response to the user visiting an online application store. In an example of recommended food delivery apps presented by GUI 116 of UI device 102, the user may select one or more of recommendations 114, which in this example, may be recommended food delivery apps provided by recommendation module 108.

For example, a user may interact with GUI 116 such that an online application store is loaded and displayed. Responsive to loading the online application store, the user may select a displayed recommended food delivery app, which may then cause computing device 112 to download the selected recommended food delivery app.

While described as identifying related applications within a single online application store, the techniques of this disclosure may also be applied across multiple different application sources, such as two different online application stores. The techniques of this disclosure do not require control of an application store to be implemented. Rather, the techniques of this disclosure may be applied whenever access to a set of applications is available.

Recommender systems, such as one that recommends apps like the example described above, filter information and present the most relevant content to individual users. Recommender systems have been deployed in many web-scale applications and play a key role in delivering a satisfactory experience for users. It is common to formulate recommender systems as a supervised machine learning problem, with the goal of increasing a user's positive engagements (e.g., clicks, watches, or purchases) with their recommendations.

Feature interactions are important components of recommender systems, as feature interactions are where multiple features have complex collaborative effects on the prediction of an outcome. For example, based on the recommended food delivery app example, it may be observed that users frequently download food delivery apps during mealtimes, indicating the feature interactions of app IDs (e.g., food delivery apps) and temporal context (e.g., mealtimes) can provide vital signals for predicting user behavior and making personalized recommendations. However, modeling feature interactions in web-scale recommender systems can be difficult, as a large number of raw features may exist, and extracted feature interactions may not generalize well to certain tasks. For example, suppose food delivery apps are being recommended to users with the features: app_id (e.g., Zomato), hour_of_day (e.g., 12 pm), and user_country (e.g., India). In this case, app_id could mean one thing for hour_of_day, and another for user_country. Further, the learned embedding representation for the app Zomato may encode various implicit information including the nature of the app, the countries in which it is popular, the times at which it is frequently used, and the language of its users, etc. However, not all of the encoded information would be useful during certain feature interaction learning. When learning the feature interaction between app_id and user_country, the information of the countries in which the app is popular is likely much more important. Thus, to effectively interact different features, semantic awareness and semantic space alignment are needed. Although transformer models may be a solution to capture feature interactions, current transformer models are not as equipped to capture the heterogeneous feature interactions present in the food delivery app example. Thus, the techniques of this disclosure provide a method for heterogeneous feature interaction learning that may provide better contextual awareness for information selection and transformation, more accurate feature interaction learning, and thus more accurate recommendations to a user that the user is more likely to download or interact with.

In accordance with techniques of this disclosure, computing system 100 may include a recommendation module 108 that provides a set of recommendations relevant to a user of computing device 112 by capturing heterogeneous feature interactions through a novel transformer model. Recommendation module 108 may represent or otherwise apply an ML module 110 configured to apply the transformer model to user-item interaction data received by computing system 100 from computing device 112. Recommendation module 108 may recommend, for example, food delivery apps to the first user of computing device 112, who may then select one of the recommended food delivery apps for download.

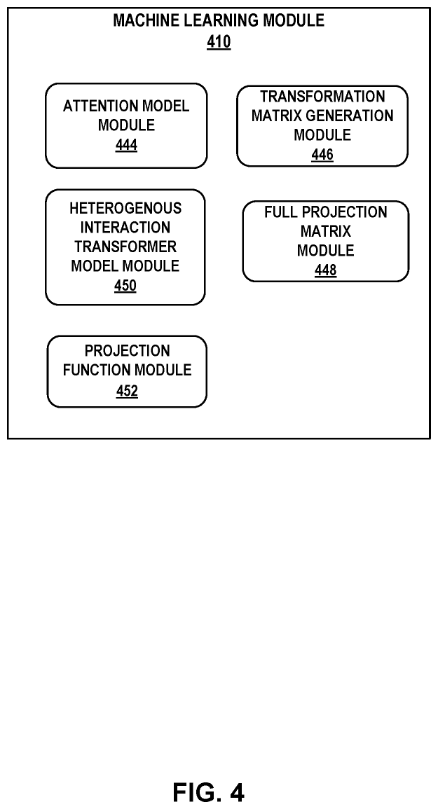

ML module 110 may further include the heterogenous feature interaction transformer model described previously, as well as one or more additional machine learning models. ML module 110 is described in greater detail below (e.g., with respect to FIG. 4). Briefly, however, ML module 110 may be trained on a large amount of data in order to generate recommendations. In some examples, ML module 110 may use one or more complex algorithms and neural networks to analyze user data. ML module 110 may also perform various natural language processing (NLP) tasks, such as machine translation, sentiment analysis, summarization, question answering, text generation, etc.

In general, recommendation module 108 may send information (e.g., user-item interaction data, location information, other contextual information, etc.) to ML module 110 only if computing system 100 receives permission from the user of computing device 112 to send the information. For example, in situations discussed here in which computing system 100 may collect, transmit, or may make use of personal information about a user (e.g., location information), the user may be provided with an opportunity to control whether programs or features of computing system 100 can collect user information (e.g., information about a user's social network, a user's social actions or activities, a user's profession, a user's preferences, or a user's current location), or to control whether and/or how computing system 100 may store and share user information.

In addition, certain data may be treated in one or more ways before it is stored, transmitted, or used so that personally identifiable information is removed. For example, a user's identity may be treated so that no personally identifiable information can be determined about the user. Thus, the user may have control over how information is collected about the user and stored, transmitted, and/or used in accordance with techniques of this disclosure.

Recommendation module 108 may provide user data received from computing device 112 to ML module 110 to generate a set of recommendations 114A-114N (collectively, “recommendations 114”). Only recommendations 114A-114D of recommendations 114 are shown and labeled in the example of FIG. 1 for ease of illustration. In some examples, recommendations 114A-114N may be sent from UI module 104 as data to UI device 102 of computing device 112 to display a GUI.

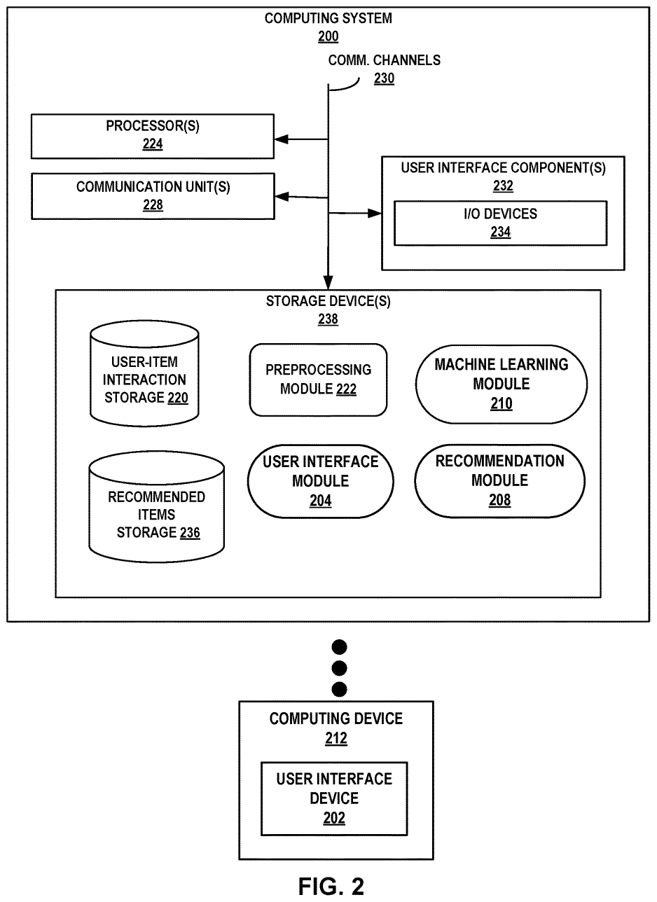

FIG. 2 is a block diagram illustrating another example computing system 200 configured to apply a machine learning module 210 for providing recommendations to a user computing device 212, in accordance with one or more techniques of this disclosure. As shown in the example of FIG. 2, computing system 200 includes processors 224, one or more communication channels 230, one or more user interface components (UIC) 232 that include one or more input/output devices 234, one or more communication units 228, and one or more storage devices 238. Storage devices 238 of computing system 200 may include user interface module 204, recommendation module 208, machine learning module 210, user-item interaction storage 220, preprocessing module 222, and recommended items storage 236. Computing system 200 may communicate with or be implemented on computing device 212 via a network. As shown in the example of FIG. 2, computing device 212 includes user interface (UI) device 202, which may be similar if not substantially similar to UI device 102 of FIG. 1.

The one or more communication units 228 of computing system 200, for example, may communicate with external devices by transmitting and/or receiving data at computing system 200, such as to and from remote computer systems or computing device 212. Example communication units 228 include a network interface card (e.g., such as an Ethernet card), an optical transceiver, a radio frequency transceiver, or any other type of device that can send and/or receive information. Other examples of communication units 228 may be devices configured to transmit and receive Ultrawideband®, Bluetooth®, GPS, 3G, 4G, and Wi-Fi®, etc. that may be found in computing devices, such as mobile devices and the like.

As shown in the example of FIG. 2, communication channels 230 may interconnect each of the components as shown for inter-component communications (physically, communicatively, and/or operatively). In some examples, communication channels 230 may include a system bus, a network connection (e.g., to a wireless connection as described above), one or more inter-process communication data structures, or any other components for communicating data between hardware and/or software locally or remotely.

One or more I/O devices 234 of computing system 200 may receive inputs and generate outputs. Examples of inputs are tactile, audio, kinetic, and optical input, to name only a few examples. Input devices of I/O devices 234, in one example, may include a touchscreen, a touchpad, a mouse, a keyboard, a voice responsive system, a video camera, buttons, a control pad, a microphone or any other type of device for detecting input from a human or machine. Output devices of I/O devices 234, may include, a sound card, a video graphics adapter card, a speaker, a display, or any other type of device for generating output to a human or machine.

User interface module 204, recommendation module 208, machine learning module 210, preprocessing module 222, user-item interaction storage 220, and recommended items storage 236 (hereinafter “modules 204-236”) may perform operations described herein using software, hardware, firmware, or a mixture of hardware, software, and firmware residing in and executing on computing system 200 or at one or more other remote computing devices (e.g., cloud-based application—not shown) or computing device 212. Computing system 200 may execute one or more of modules 204-236, with one or more processors 224 or may execute any or part of one or more of modules 204-236 as or within a virtual machine executing on underlying hardware. One or more of modules 204-236 may be implemented in various ways, for example, as a downloadable or pre-installed application, remotely as a cloud application, or as part of the operating system of computing system 200. Other examples of computing system 200 that implement techniques of this disclosure may include additional components not shown in FIG. 2.

In the example of FIG. 2, one or more processors 224 may implement functionality and/or execute instructions within computing system 200. For example, one or more processors 224 may receive and execute instructions that provide the functionality of UIC 232, communication units 228, one or more storage devices 238 and an operating system to perform one or more operations as described herein. For example, one or more processors 224 may receive and execute instructions that provide the functionality of some or all of modules 204-236 to perform one or more operations and various functions described herein. The one or more processors 224 include a central processing unit (CPU). Examples of CPUs include, but are not limited to, a digital signal processor (DSP), a general-purpose microprocessor, a tensor processing unit (TPU); a neural processing unit (NPU); a neural processing engine; a core of a CPU, VPU, GPU, TPU, NPU or another processing device, an application specific integrated circuit (ASIC), a field programmable logic array (FPGA), or other equivalent integrated or discrete logic circuitry, or other equivalent integrated or discrete logic circuitry.

One or more storage devices 238 within computing system 200 may store information, such as data associated with user-item interactions in a recommender system or other data discussed herein, for processing during the operation of computing system 200. In some examples, one or more storage devices of storage devices 238 may be a volatile or temporary memory. Examples of volatile memories include random access memories (RAM), dynamic random-access memories (DRAM), static random-access memories (SRAM), and other forms of volatile memories known in the art. Storage devices 238, in some examples, may also include one or more computer-readable storage media. Storage devices 238 may be configured to store larger amounts of information for longer terms in non-volatile memory than volatile memory. Examples of non-volatile memories include magnetic hard disks, optical discs, floppy discs, flash memories, or forms of electrically programmable memories (EPROM) or electrically erasable and programmable (EEPROM) memories. Storage devices 238 may store program instructions and/or data associated with the modules 202-236 of FIG. 2.

User-item interaction storage 220 is a storage repository for user-item interaction data received by computing system 200 from computing device 212. For example, computing system may receive information indicative of interactions between a user of computing device 212 and a plurality of previously recommended items recommended by recommendation module 208. User-item interaction storage 220 may include all or a portion of the user-item interaction data received using the techniques of this disclosure. In some examples, user-item interaction storage 220 may operate, at least in part, as a cache for user-item interaction data retrieved from a remote computing system (e.g., using one or more communication units 228) or other computing devices. In general, user-item interaction storage 220 may be configured as a database, flat file, table, or other data structure stored within storage device 238. In some examples, user-item interaction storage 220 is shared between various modules executing at computing system 200 (e.g., between one or more of modules 204-236 or other modules not shown in FIG. 2). In other examples, a different data repository is configured for a module executing at computing system 200 that requires a data repository. Each data repository may be configured and managed by different modules and may store data in a different manner. In some examples, computing system 200 may receive, from computing device 212, input indicative of interactions between a user of computing device 212 and a plurality of recommended items recommended by recommendation module 208, wherein the input data is stored in user-item interaction storage 220. In some examples, computing system 200 may receive and store input data from computing device 212 over a specified period of time. In some examples, the data stored in user-item interaction storage 220 may be preprocessed by preprocessing module 222. Preprocessing module 222 may be configured as a module for preprocessing data stored in user-item interaction storage 220 prior to recommendation module 208 sending the data to or implementing machine learning module 210. In some examples, preprocessing module 222 may perform various operations on the input data stored in user-item interaction storage 220.

In some implementations, preprocessing the input data may include extracting one or more additional features from raw input data. For example, feature extraction techniques may be applied to the input data to generate one or more new, additional features. Example feature extraction techniques include edge detection; corner detection; blob detection; ridge detection; scale-invariant feature transform; motion detection; optical flow; Hough transform; etc.

In some implementations, the extracted features may include or be derived from transformations of the input data into other domains and/or dimensions. As an example, the extracted features may include or be derived from transformations of the input data into the frequency domain. For example, wavelet transformations and/or fast Fourier transforms may be performed on the input data to generate additional features.

In some implementations, the extracted features may include statistics calculated from the input data or certain portions or dimensions of the input data. Example statistics include the mode, mean, maximum, minimum, or other metrics of the input data or portions thereof.

In some implementations, as described above, the input data may be sequential in nature. In some instances, the sequential input data may be generated by sampling or otherwise segmenting a stream of input data. As one example, frames may be extracted from a video. In some implementations, sequential data may be made non-sequential through summarization.

As another example of preprocessing techniques, portions of the input data may be imputed. For example, additional synthetic input data may be generated through interpolation and/or extrapolation.

As another example of preprocessing techniques, some or all of the input data may be scaled, standardized, normalized, generalized, and/or regularized. Example regularization techniques include ridge regression; least absolute shrinkage and selection operator (LASSO); elastic net; least-angle regression; cross-validation; L1 regularization; L2 regularization; etc. For example, some or all of the input data may be normalized by subtracting the mean across a given dimension's feature values from each feature value and then dividing by the standard deviation or another metric.

As another example of preprocessing techniques, some or all or the input data may be quantized or discretized. In some cases, qualitative features or variables included in the input data may be converted to quantitative features or variables. For example, one hot encoding may be performed.

In some examples, dimensionality reduction techniques may be applied to the input data prior to input into preprocessing module 222. Several examples of dimensionality reduction techniques are provided above, including, for example, principal component analysis; kernel principal component analysis; graph-based kernel principal component analysis; principal component regression; partial least squares regression; Sammon mapping; multidimensional scaling; projection pursuit; linear discriminant analysis; mixture discriminant analysis; quadratic discriminant analysis; generalized discriminant analysis; flexible discriminant analysis; autoencoding; etc.

As described above, recommendation module 208 may be configured to provide a set of recommendations relevant to a user of computing device 212 based on the output of machine learning module 210, which may indicate the likelihood the user will engage with an item recommended by recommendation module 208. Responsive to preprocessing module 222 preprocessing the user-item interaction data stored in user-item interaction storage 220, recommendation module 208 may send the preprocessed data to machine learning module 210 or otherwise apply machine learning module 210 to the preprocessed data. Machine learning module 210 may include various machine-learned models including, but not limited to, DNNs, attention models, and transformer models, such as those described previously. Specifically, machine learning module 210 may include a heterogenous feature interaction transformer model for learning heterogeneous feature interactions in the preprocessed user-item interaction data. In some examples, the machine-learned models included in machine learning module 210 may be trained for specific tasks relating to the user-item interactions.

In some examples, machine learning module 210 may implement other machine-learned models that may be used in place of or in conjunction with the models that are described with respect to FIG. 4. For example, machine learning module 210 may be or include one or more of various different types of machine-learned models. In particular, in some implementations, machine learning module 210 may perform classification, summarization, name generation, regression, clustering, anomaly detection, recommendation generation, and/or other tasks.

In some implementations, machine learning module 210 may perform various types of classification based on the input data. For example, machine learning module 210 may perform binary classification or multiclass classification. In binary classification, the output data may include a classification of the input data into one of two different classes. In multiclass classification, the output data may include a classification of the input data into one (or more) of more than two classes. The classifications may be single-label or multi-label. Machine learning module 210 may perform discrete categorical classification in which the input data is simply classified into one or more classes or categories.

In some implementations, machine learning module 210 may perform various types of natural language processing (NLP) based on the input data. For example, machine learning module 210 may summarize, translate, or organize the input data. The natural language processing (NLP) model may use recurrent neural networks (RNNs) and/or transformer models (self-attention models), such as GPT-3, BERT, and T5.

In some implementations, machine learning module 210 may perform classification in which machine learning module 210 provides, for each of one or more classes, a numerical value descriptive of a degree to which it is believed that the input data should be classified into the corresponding class. In some instances, the numerical values provided by machine learning module 210 may be referred to as “confidence scores” that are indicative of a respective confidence associated with the classification of the input into the respective class. In some implementations, the confidence scores may be compared to one or more thresholds to render a discrete categorical prediction. In some implementations, only a certain number of classes (e.g., one) with the relatively largest confidence scores may be selected to render a discrete categorical prediction.

Machine learning module 210 may output a probabilistic classification. For example, machine learning module 210 may predict, given a sample input, a probability distribution over a set of classes. Thus, rather than outputting only the most likely class to which the sample input should belong, machine learning module 210 may output, for each class, a probability that the sample input belongs to such class. In some implementations, the probability distribution over all possible classes may sum to one. In some implementations, a Softmax function or other type of function or layer may be used to squash a set of real values respectively associated with the possible classes to a set of real values in the range (0, 1) that sum to one.

In some examples, the probabilities provided by the probability distribution may be compared to one or more thresholds to render a discrete categorical prediction. In some implementations, only a certain number of classes (e.g., one) with the relatively largest predicted probability may be selected to render a discrete categorical prediction.

In cases in which machine learning module 210 performs classification, machine learning module 210 may be trained using supervised learning techniques. For example, machine learning module 210 may be trained on a training dataset that includes training examples labeled as belonging (or not belonging) to one or more classes.

In some implementations, machine learning module 210 may perform regression to provide output data in the form of a continuous numeric value. The continuous numeric value may correspond to any number of different metrics or numeric representations, including, for example, currency values, scores, or other numeric representations. In examples, machine learning module 210 may perform linear regression, polynomial regression, or nonlinear regression. In examples, machine learning module 210 may perform simple regression or multiple regression. As described above, in some implementations, a Softmax function or other function or layer may be used to squash a set of real values respectively associated with two or more possible classes to a set of real values in the range (0, 1) that sum to one.

Machine learning module 210 may perform various types of clustering. For example, machine learning module 210 may identify one or more clusters to which the input data most likely corresponds. Machine learning module 210 may identify one or more clusters within the input data. That is, in instances in which the input data includes multiple objects, documents, or other entities, machine learning module 210 may sort the multiple entities included in the input data into a number of clusters. In some implementations in which machine learning module 210 performs clustering, machine learning module 210 may be trained using unsupervised learning techniques.

Machine learning module 210 may, in some cases, act as an agent within an environment. For example, machine learning module 210 may be trained using reinforcement learning, which will be discussed in further detail below.

In some implementations, machine learning module 210 may be a parametric model while, in other implementations, machine learning module 210 may be a non-parametric model. In some implementations, machine learning module 210 may be a linear model while, in other implementations, machine learning module 210 may be a non-linear model.

As described above, machine learning module 210 may be or include one or more of various different types of machine-learned models. Examples of such different types of machine-learned models are provided below for illustration. One or more of the example models described below may be used (e.g., combined) to provide the output data in response to the input data. Additional models beyond the example models provided below may be used as well.

In some implementations, machine learning module 210 may be or include one or more classifier models such as, for example, linear classification models; quadratic classification models; etc. Machine learning module 210 may be or include one or more regression models such as, for example, simple linear regression models; multiple linear regression models; logistic regression models; stepwise regression models; multivariate adaptive regression splines; locally estimated scatterplot smoothing models; etc.

In some implementations, machine learning module 210 may be or include one or more artificial neural networks (also referred to simply as neural networks). A neural network may include a group of connected nodes, which also may be referred to as neurons or perceptrons. A neural network may be organized into one or more layers. Neural networks that include multiple layers may be referred to as “deep” networks. A deep network may include an input layer, an output layer, and one or more hidden layers positioned between the input layer and the output layer. The nodes of the neural network may be connected or non-fully connected.

Machine learning module 210 may be or include one or more feed-forward neural networks. In feed forward-networks, the connections between nodes do not form a cycle. For example, each connection may connect a node from an earlier layer to a node from a later layer.

In some instances, machine learning module 210 may be or include one or more recurrent neural networks. In some instances, at least some of the nodes of a recurrent neural network may form a cycle. Recurrent neural networks may be especially useful for processing input data that is sequential in nature. In particular, in some instances, a recurrent neural network may pass or retain information from a previous portion of the input data sequence to a subsequent portion of the input data sequence through the use of recurrent or directed cyclical node connections.

In some examples, sequential input data may include time-series data (e.g., sensor data versus time or imagery captured at different times). For example, a recurrent neural network may analyze sensor data versus time to detect or predict a swipe direction, to perform handwriting recognition, etc. Sequential input data may include words in a sentence (e.g., for natural language processing, speech detection or processing, etc.); notes in a musical composition; sequential actions taken by a user (e.g., to detect or predict sequential application usage); sequential object states; etc.

Example recurrent neural networks include long short-term (LSTM) recurrent neural networks; gated recurrent units; bi-direction recurrent neural networks; continuous-time recurrent neural networks; neural history compressors; echo state networks; Elman networks; Jordan networks; recursive neural networks; Hopfield networks; fully recurrent networks; sequence-to-sequence configurations; etc.

In some implementations, machine learning module 210 may be or include one or more convolutional neural networks. In some instances, a convolutional neural network may include one or more convolutional layers that perform convolutions over input data using learned filters.

Filters may also be referred to as kernels. Convolutional neural networks may be especially useful for vision problems such as when the input data includes imagery such as still images or video. However, convolutional neural networks may also be applied for natural language processing.

In some examples, machine learning module 210 may be or include one or more generative networks such as, for example, generative adversarial networks. Generative networks may be used to generate new data such as artificial feedback texts.

Machine learning module 210 may be or include an autoencoder. In some instances, the aim of an autoencoder is to learn a representation (e.g., a lower-dimensional encoding) for a set of data, typically for the purpose of dimensionality reduction. For example, in some instances, an autoencoder may seek to encode the input data and then provide output data that reconstructs the input data from the encoding. Recently, the autoencoder concept has become more widely used for learning generative models of data. In some instances, the autoencoder may include additional losses beyond reconstructing the input data.

Machine learning module 210 may be or include one or more other forms of artificial neural networks such as, for example, deep Boltzmann machines; deep belief networks; stacked autoencoders; etc. Any of the neural networks described herein may be combined (e.g., stacked) to form more complex networks.

In an example in which the input data does not include feature embeddings, one or more neural networks may be used to provide an embedding based on the input data. For example, the embedding may be a representation of knowledge abstracted from the input data into one or more learned dimensions. In some instances, embeddings may be a useful source for identifying related entities. In some instances, embeddings may be extracted from the output of the network, while in other instances embeddings may be extracted from any hidden node or layer of the network (e.g., a close to final but not final layer of the network). Embeddings may be useful for performing auto-suggest next video, product suggestion, entity or object recognition, etc. In some instances, embeddings are useful inputs for downstream models. For example, embeddings may be useful to generalize input data (e.g., search queries) for a downstream model or processing system.

In some implementations, the functionalities of preprocessing module 222 may be performed by machine learning module 210, in which machine learning module 210 may perform one or more dimensionality reduction techniques such as, for example, principal component analysis; kernel principal component analysis; graph-based kernel principal component analysis; principal component regression; partial least squares regression; Sammon mapping; multidimensional scaling; projection pursuit; linear discriminant analysis; mixture discriminant analysis; quadratic discriminant analysis; generalized discriminant analysis; flexible discriminant analysis; autoencoding; etc.

In some implementations, machine learning module 210 may perform or be subjected to one or more reinforcement learning techniques such as Markov decision processes; dynamic programming; Q functions or Q-learning; value function approaches; deep Q-networks; differentiable neural computers; asynchronous advantage actor-critics; deterministic policy gradient; etc.

In some implementations, machine learning module 210 may be an autoregressive model. In some instances, an autoregressive model may specify that the output data depends linearly on its own previous values and on a stochastic term. In some instances, an autoregressive model may take the form of a stochastic difference equation. One example of an autoregressive model is WaveNet, which is a generative model for raw audio.

In some implementations, machine learning module 210 may include or form part of a multiple model ensemble. As one example, bootstrap aggregating may be performed, which may also be referred to as “bagging.” In bootstrap aggregating, a training dataset is split into a number of subsets (e.g., through random sampling with replacement) and a plurality of models are respectively trained on the number of subsets. At inference time, respective outputs of the plurality of models may be combined (e.g., through averaging, voting, or other techniques) and used as the output of the ensemble.

One example ensemble is a random forest, which may also be referred to as a random decision forest. Random forests are an ensemble learning method for classification, regression, and other tasks. Random forests are generated by producing a plurality of decision trees at training time. In some instances, at inference time, the class that is the mode of the classes (classification) or the mean prediction (regression) of the individual trees may be used as the output of the forest. Random decision forests may correct for decision trees' tendency to overfit their training set.

Another example ensemble technique is stacking, which can, in some instances, be referred to as stacked generalization. Stacking includes training a combiner model to blend or otherwise combine the predictions of several other machine-learned models. Thus, a plurality of machine-learned models (e.g., of the same or different type) may be trained based on training data. In addition, a combiner model may be trained to take the predictions from the other machine-learned models as inputs and, in response, produce a final inference or prediction. In some instances, a single-layer logistic regression model may be used as the combiner model.

Another example of ensemble techniques is boosting. Boosting may include incrementally building an ensemble by iteratively training weak models and then adding to a final strong model. For example, in some instances, each new model may be trained to emphasize the training examples that previous models misinterpreted (e.g., misclassified).

For example, a weight associated with each of such misinterpreted examples may be increased. One common implementation of boosting is AdaBoost, which may also be referred to as Adaptive Boosting. Other example boosting techniques include LPBoost; TotalBoost; BrownBoost; xgboost; MadaBoost, LogitBoost, gradient boosting; etc. Furthermore, any of the models described above (e.g., regression models and artificial neural networks) may be combined to form an ensemble. As an example, an ensemble may include a top-level machine-learned model or a heuristic function to combine and/or weight the outputs of the models that form the ensemble.

In some implementations, multiple machine-learned models (e.g., that form an ensemble may be linked and trained jointly (e.g., through backpropagation of errors sequentially through the model ensemble). However, in some implementations, only a subset (e.g., one) of the jointly trained models is used for inference.

In some implementations, machine learning module 210 may be used to preprocess the input data for subsequent input into another model. For example, machine learning module 210 may perform dimensionality reduction techniques and embeddings (e.g., matrix factorization, principal components analysis, singular value decomposition, word2vec/GLOVE, and/or related approaches); clustering; and even classification and regression for downstream consumption. Many of these techniques have been discussed above and will be further discussed below.

As discussed above, machine learning module 210 may be trained or otherwise configured to receive the input data and, in response, provide the output data. The input data may include different types, forms, or variations of input data. In some implementations, machine learning module 210 may receive and use the input data in its raw form. As described herein, the raw input data may be preprocessed by preprocessing module 222.

In some implementations, during training, the input data may be intentionally deformed in any number of ways to increase model robustness, generalization, or other qualities. Example techniques to deform the input data include adding noise; changing color, shade, or hue; magnification; segmentation; amplification; etc.

In response to receipt of the input data, machine learning module 210 may provide the output data. The output data may include different types, forms, or variations of output data. As examples, in various implementations, the output data may include content, either stored locally on the user device or in the cloud, that is relevantly shareable along with the initial content selection.

As discussed above, in some implementations, the output data may include various types of classification data (e.g., binary classification, multiclass classification, single label, multi-label, discrete classification, regressive classification, probabilistic classification, etc.) or may include various types of regressive data (e.g., linear regression, polynomial regression, nonlinear regression, simple regression, multiple regression, etc.). In other instances, the output data may include clustering data, anomaly detection data, recommendation data, or any of the other forms of output data discussed above.

In some implementations, the output data may influence downstream processes or decision-making. As one example, in some implementations, the output data may be interpreted and/or acted upon by a rules-based regulator.

The present disclosure provides techniques that include or otherwise leverage one or more machine-learned models to classify feedback texts, determine a number of issues from the classified feedback texts, and generate themes from the issues. Any of the different types or forms of input data described above may be combined with any of the different types or forms of machine-learned models described above to provide any of the different types or forms of output data described above.

The techniques of the present disclosure may be implemented by or otherwise executed on one or more computing devices such as computing device 212. Examples of computing device 212 include user computing devices (e.g., laptops, desktops, and mobile computing devices such as tablets, smartphones, wearable computing devices, etc.); embedded computing devices (e.g., devices embedded within a vehicle, camera, image sensor, industrial machine, satellite, gaming console or controller, or home appliance such as a refrigerator, thermostat, energy meter, home energy manager, smart home assistant, etc.); other computing devices; or combinations thereof. Computing system 200 that implements machine learning module 210 or other aspects of the present disclosure may include a number of hardware components that enable the performance of the techniques described herein. For example, computing system 200 may include one or more memory devices that store some or all of machine learning module 210. For example, machine learning module 210 may be a structured numerical representation that is stored in memory. The one or more memory devices may also include instructions for implementing machine learning module 210 or performing other operations. Example memory devices include RAM, ROM, EEPROM, EPROM, flash memory devices, magnetic disks, etc., and combinations thereof.

Computing system 200 may also include one or more processing devices that implement some or all of machine learning module 210 and/or perform other related operations. Example processing devices include one or more of: a central processing unit (CPU); a visual processing unit (VPU); a graphics processing unit (GPU); a tensor processing unit (TPU); a neural processing unit (NPU); a neural processing engine; a core of a CPU, VPU, GPU, TPU, NPU or another processing device; an application specific integrated circuit (ASIC); a field programmable gate array (FPGA); a co-processor; a controller; or combinations of the processing devices described above. Processing devices may be embedded within other hardware components such as, for example, an image sensor, accelerometer, etc.

Machine learning module 210 described herein may be trained according to one or more of various different training types or techniques. For example, in some implementations, machine learning module 210 may be trained using supervised learning, in which machine learning module 210 is trained on a training dataset that includes instances or examples that have labels. The labels may be manually applied by experts, generated through crowdsourcing, or provided by other techniques (e.g., by physics-based or complex mathematical models). In some implementations, if the user has provided consent, the training examples may be provided by the user computing device. In some implementations, this process may be referred to as personalizing the model.

In some implementations, backward propagation of errors may be used in conjunction with an optimization technique (e.g., gradient-based techniques) to train machine learning module 210 (e.g., when the machine-learned model is a multi-layer model such as an artificial neural network). For example, an iterative cycle of propagation and model parameter (e.g., weights) update may be performed to train machine learning module 210. Example backpropagation techniques include truncated backpropagation through time, Levenberg-Marquardt backpropagation, etc.

In some implementations, machine learning module 210 described herein may be trained using unsupervised learning techniques. Unsupervised learning may include inferring a function to describe hidden structure from unlabeled data. For example, a classification or categorization may not be included in the data. Unsupervised learning techniques may be used to produce machine-learned models capable of performing clustering, anomaly detection, learning latent variable models, or other tasks.

Machine learning module 210 may be trained using semi-supervised techniques which combine aspects of supervised learning and unsupervised learning. Machine learning module 210 may be trained or otherwise generated through evolutionary techniques or genetic algorithms. In some implementations, machine learning module 210 described herein may be trained using reinforcement learning. In reinforcement learning, an agent (e.g., model) may take actions in an environment and learn to maximize rewards and/or minimize penalties that result from such actions. Reinforcement learning may differ from the supervised learning problem in that correct input/output pairs are not presented, nor sub-optimal actions explicitly corrected.

In some implementations, one or more generalization techniques may be performed during training to improve the generalization of machine learning module 210. Generalization techniques may help reduce overfitting of machine learning module 210 to the training data. Example generalization techniques include dropout techniques; weight decay techniques; batch normalization; early stopping; subset selection; stepwise selection; label smoothing; etc.

In some implementations, machine learning module 210 described herein may include or otherwise be impacted by a number of hyperparameters, such as, for example, learning rate, number of layers, number of nodes in each layer, number of leaves in a tree, number of clusters; etc. Hyperparameters may affect model performance. Hyperparameters may be hand selected or may be automatically selected through the application of techniques such as, for example, grid search; black-box optimization techniques (e.g., Bayesian optimization, random search, etc.); gradient-based optimization; etc. Example techniques and/or tools for performing automatic hyperparameter optimization include Hyperopt; Auto-WEKA; Spearmint; Metric Optimization Engine (MOE); etc.

In some implementations, various techniques may be used to optimize and/or adapt the learning rate when the model is trained. Example techniques and/or tools for performing learning rate optimization or adaptation include Adagrad; Adaptive Moment Estimation (ADAM); Adadelta; RMSprop; etc.

In some implementations, transfer learning techniques may be used to provide an initial model from which to begin training of machine learning module 210 described herein.

In some implementations, machine learning module 210 described herein may be included in different portions of computer-readable code on a computing device. In one example, machine learning module 210 may be included in a particular application or program and used (e.g., exclusively) by such particular application or program. Thus, in one example, a computing device may include a number of applications, and one or more of such applications may contain its own respective machine learning library and machine-learned model(s).

In another example, machine learning module 210 described herein may be included in an operating system of a computing device such as computing device 212 (e.g., in a central intelligence layer of an operating system) and may be called or otherwise used by one or more applications that interact with the operating system. In some implementations, each application may communicate with the central intelligence layer (and model(s) stored therein) using an application programming interface (API) (e.g., a common, public API across all applications).

In some implementations, the central intelligence layer may communicate with a central device data layer. The central device data layer may be a centralized repository of data for computing device 212. The central device data layer may communicate with a number of other components of computing device 212, such as, for example, one or more sensors, a context manager, a device state component, and/or additional components. In some implementations, the central device data layer may communicate with each device component using an API (e.g., a private API).

The technology discussed herein refers to servers, databases, software applications, and other computer-based systems, as well as actions taken, and information sent to and from such systems. The inherent flexibility of computer-based systems allows for a great variety of possible configurations, combinations, and divisions of tasks and functionality between and among components. For instance, processes discussed herein may be implemented using a single device or component or multiple devices or components working in combination.

Databases and applications may be implemented on a single system or distributed across multiple systems. Distributed components may operate sequentially or in parallel.

In addition, the machine learning techniques described herein are readily interchangeable and combinable. Although certain example techniques have been described, many others exist and may be used in conjunction with aspects of the present disclosure.

In some implementations, transfer learning (TL) may be used. Transfer learning involves reusing a model and its model parameters obtained while solving one problem and applying it to a different but related problem. Models trained on very large data sets may be retrained or fine-tuned on additional data. Often, all model designs and their parameters on a source model are copied except output layer(s). The output layers(s) are often called the head, and other layers are often called the base. The source parameters may be considered to contain the knowledge learned from the source dataset and this knowledge may also be applicable to a target dataset. Fine-tuning may include updating the head parameters with the body parameters being fixed or updated in a later step. Pretrained models, such as T5 models, are often available from Hugging Face or off of GitHub.

A brief overview of example machine-learned models and associated techniques has been provided by the present disclosure. For additional details, readers should review the following references: Machine Learning A Probabilistic Perspective (Murphy); Rules of Machine Learning: Best Practices for ML Engineering (Zinkevich); Deep Learning (Goodfellow); Reinforcement Learning: An Introduction (Sutton); and Artificial Intelligence: A Modern Approach (Norvig).

The output of machine learning module 210 may be stored in recommended items storage 236. Recommendation module 208 may then generate recommendations to a user of computing device 212, wherein the recommendations are based on the data stored in recommended items storage 236. The recommendations generated by recommendation module 208 may be presented to a user of computing device 212 via user interface device 202. More specifically, UI module 204 may receive data indicating the recommendations from recommendation module 208. UI module 204 may then send recommendation data to UI device 202 of computing device 212 to display a GUI, wherein the GUI presents the set of recommendations to the user, such as GUI 116 presents recommendations 114 in FIG. 1.

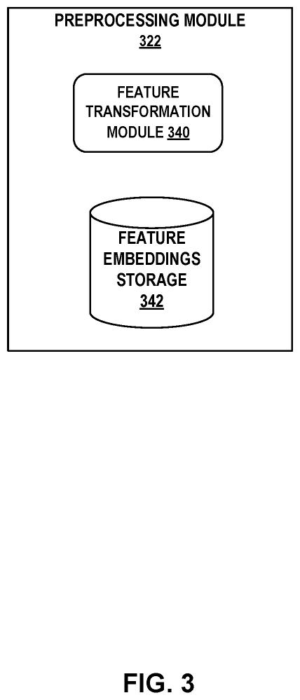

FIG. 3 is a conceptual diagram illustrating a data preprocessing module 322 for heterogeneous feature interaction learning, in accordance with one or more techniques of this disclosure. In the example of FIG. 3, preprocessing module 322 further includes feature transformation module 340 and feature embeddings storage 342. As described above, preprocessing module 322 may retrieve data stored in user-item interaction storage 220 of FIG. 2. More specifically, feature transformation module 340 may retrieve, from user-item interaction storage 220, user-item interaction data including one or more of encoded categorical features of one or more user-item pairs, encoded dense scalar features of one or more user-item pairs, and encoded task embeddings. Categorical features are variables that can take on a limited, fixed set of possible values (e.g., gender (male or female), occupation (doctor, engineer, or teacher), or product category (electronics, clothing, or books)) which are typically represented as discrete values or integers in a dataset, and can be one-hot encoded to transform them into a binary format. Dense scalar features are continuous variables that can take on any real value within a specified range (e.g., age, income, or the price of a product), are typically represented as floating point numbers in a dataset, and can be normalized or standardized to ensure that they have a similar scale and magnitude. In some examples, task embeddings may be vectors that encode task-specific information. In a recommender system, for example, the primary task may be to provide personalized recommendations to users based on their preferences and behavior. Additional sub-tasks may include, but are not limited to, collaborative fitting, content-based filtering, hybrid recommender, contextual recommendations, sequential recommendations, explainable recommendations, cold-start recommendations, and diverse and serendipitous discovery. In some examples, task embeddings may be low-dimensional representations of one or more user-item pairs that capture their underlying characteristics or preferences. Task embeddings can be learned using machine learning techniques such as matrix factorization, deep neural networks, or graph embeddings, and can be used to predict user-item interactions or recommendations. Further, task embeddings are typically represented as vectors in a high-dimensional space, and can be visualized or clustered to reveal patterns or insights in the data.

Feature transformation module 340 may transform the encoded categorical features, encoded dense scalar features, and encoded task embeddings into a feature embeddings list, wherein the feature embeddings list includes pairs of feature embeddings. In some examples, wherein the input received from computing system 100 does not include encoded features and task embeddings, feature transformation module 340 may also encode the features and task embeddings prior to transforming the features and task embeddings into a feature embeddings list. Feature transformation module 340 may then send the feature embeddings list to feature embeddings storage 342, wherein feature embeddings storage 342 may store the feature embeddings list. Feature embeddings storage 342 may also store the encoded task embeddings in addition to the feature embeddings list. In general, feature embeddings storage 342 may be configured as a database, flat file, table, or other data structure stored within computing system 200. In some examples, feature embeddings storage 342 is shared between various modules executing at computing system 200. In other examples, a different data repository is configured for a module executing at computing system 200 that requires a data repository.

For example, the data retrieved by feature transformation module 340 from user-item interaction storage 220 may include categorical features, dense features, and one or more task embeddings. In some examples, the task embedding can be regarded as special classification token. Feature transformation module 340 may be configured to transform or encode the data features such that the data can be analyzed by machine learning module 210. Mathematically, if x ∈ [symbol] ^{d}^{ₓ} denotes the features of a (user, item) pair, there are categorical features [symbol] and dense features [symbol] , wherein, and throughout this disclosure, the number of categorical and dense features are | [symbol] | and | [symbol] |, respectively, and computing system 200 is configured to predict if a user of computing device 212 will engage with an item from a set of recommended items based on input features x. As described herein, in some examples, the categorical features are represented with one-hot encoding. In some examples, the dense features can be considered as special embedding features, with the embedding dimension being 1.

As aforementioned, feature interaction learning may allow machine learning model module 210 comprising, for example, a heterogenous feature interaction transformer model, to better capture more complex relationships among data features, thereby providing virtual information for more accurate recommendations provided by recommendation module 208. In this disclosure, heterogeneous feature interaction learning can be defined as follows:
Given input with | [symbol] | features and the input as

$$x = {\{ {x}_{i} \}}_{i = 1}^{\vert ℱ \vert} ,$$

a z-order feature interaction is to learn a unique non-additive mapping function p [symbol] (⋅) that map from the feature list [symbol] with z features (i.e., [xᵢₗ, . . . , x_{iz}]) to a new representation or a scalar to capture the complex relationships among the feature list [symbol] . When z=2, p [symbol] (⋅) captures the second order feature interactions. For example, g([x₁, x₂]) w₁x₁+w₂x₂ is not a 2-order feature
interaction, as w₁x₁+w₂x₂ is additive. Meanwhile,

$$g ( [ {x}_{1} , {x}_{2} ] ) = {x}_{1}^{T} {x}_{2}$$

is a 2-order feature interaction; an

$${p}^{1 , 2} ( \cdot ) = {p}^{2 , 1} ( \cdot ) = {x}_{1}^{T} {x}_{2} ,$$

meaning the heterogeneous feature interaction is symmetric.

Throughout this disclosure, scalars are denoted by lower case italicized letters (a, b, . . . ), vectors are denoted by lowercase letters (a, b, . . . ), and matrices are denoted by upper case letters (A, B, . . . ).

In some examples, the data may include multiple task embeddings, wherein each task embedding represents information of the corresponding training objective. The task embeddings may be considered model parameters for machine learning module 210 and are learned through end-to-end model training. The number of task embeddings may be denoted as t. Responsive to transformation module 340 transforming the data into a list of feature embeddings and storing the list of feature embeddings in feature embeddings storage 342, machine learning module 210 may then retrieve the list of feature embeddings for input.

Input categorical features are often sparse and of high dimensions, and directly using a one-hot encoding for model training could easily lead to model overfitting. Therefore, a common strategy is to project categorical features into a low-dimension dense space. In particular, feature transformation module 340 may further learn a projection matrix

$${W}_{i}^{𝒞} ∈ {ℝ}^{{V}_{i} \times d}$$

related to each categorical feature, and

$${e}_{i} = \text{?} \text{?}$$

where eᵢ ∈

$${ℝ}^{d} , \text{?} ∈ {\{ 0 , 1 \}}^{V i} ,$$

Vᵢ is the dimensions of the one-hot encoding for feature

$$\text{?} ,$$

and d is the model dimension. The dense embedded vector eᵢ may then be used as the representation of the categorical feature

$$\text{?} . \{ \text{?}$$

are the model parameters and referred to in this disclosure as embedding look-up tables.

Dense scalar features may be numerical features. In some examples, dense scalar features are potentially from very different distributions. Thus, dense scalar features may be transformed by feature transformation module 340 to a similar distribution (i.e., uniform distribution) to ensure numerical stability. Additionally, in web-scale applications, there are often a lot of dense scalar features, and information included in dense scalar features is usually much less compared with categorical features. Therefore, the dense scalar features may be aggregated and projected into [symbol] embeddings, where [symbol] is a hyper-parameter chosen by empirical results, [symbol] «| [symbol] |. In some examples, the projection function [symbol] (⋅) is a multilayer perceptron (MLP) with nonlinear activation functions, hence:

$${e}_{i} = {split}_{i} ( {f}_{𝒟} ( concat ( normalize ( \{ {x}_{i}^{𝒟} \} ) ) ) , {split}_{s i z e} = d )$$

where eᵢ ∈ [symbol] _{d}, concat(⋅) is the concatenation function, normalize(⋅) is the feature transformation function, and splitᵢ (⋅, split_size) is a function to split the input tensor into tensors with equal dimension of split_size and takes the i-th tensor as output. In transformer-based architectures, the inference cost scales quadratically with the length of input embedding list. By aggregating | [symbol] | dense scalar features into [symbol] embeddings, the length of feature embeddings is reduced, and as a consequence, the inference cost is also reduced, albeit with a trade-off of adding [symbol] (⋅). To summarize on preprocessing module 322, the | [symbol] | categorical features, | [symbol] | dense scalar features, and t task embeddings are transformed, by feature transformation module 340, into a list of feature embeddings with the model dimension d that is then stored in feature embeddings storage 342. The number of output embeddings from preprocessing module 322 is L=| [symbol] |+ [symbol] +T. For ease of discussion, the task embeddings are also regarded as special features in the embedding list. Therefore, “feature interactions” refers to not only interactions among features, but also between features and tasks.

FIG. 4 is a conceptual diagram illustrating a machine learning module 410 for heterogeneous feature interaction learning, in accordance with one or more techniques of this disclosure. As shown in the example of FIG. 4, machine learning module 410 further comprises attention model module 444, transformation matrix generation module 446, heterogenous interaction transformer model module 450, full projection matrix module 448, and projection function module 452. Machine learning module 410 may be applied by recommendation module 208 of FIG. 2, wherein machine learning module 410 utilizes the aforementioned components and data for feature interaction learning.

Attention model module 444 may include a machine-learned model such as an attention model. For example, attention model module 444 may comprise a heterogeneous attention model comprising a heterogeneous multi-head self-attention layer that learns individual query, key, and value projection matrices for each individual feature embedding in each pair of feature embeddings included in the feature embeddings list. Heterogenous interaction transformer model module 450 may include a machine-learned model such as a transformer model. Specifically, heterogenous interaction transformer model module 450 may comprise a heterogenous interaction transformer model. Projection function module 452 may include a machine-learned model trained on a variety of training tasks that outputs a final prediction. The training tasks may be flexibly configured based on the recommendation application. For example, the training task may be a classification task if the labels are click or installation. The training task may also be a regression task, such as in the case of watch time. Projection function module 452 may comprise a DNN, such as a multi-layer perceptron tower. Details of such modules and machine-learned models are described further below.

Attention model module 444 may comprise a heterogeneous attention model comprising a heterogeneous multi-head self-attention layer. Attention model module 444 may retrieve feature embeddings list from feature embeddings storage 342, in which attention model module 444 learns individual query, key, and value projection matrices for each individual feature embedding in each pair of feature embeddings.

The following series of operations may be implemented by attention model module 444. In this example, attention model module 444 provides an example modification to the multi-head self-attention layer in the general transformer model by providing a heterogeneous multi-head self-attention layer. The heterogeneous multi-head self-attention layer may comprise a plurality of attention weight sets, wherein each attention weight set from the plurality of attention weight sets corresponds to a subset of the feature embeddings list that includes pairs of feature embeddings. The pairs of feature embeddings may include at least one user embedding and at least one item embedding. The heterogeneous multi-head self-attention layer may further comprise a weighting function that determines, based on the feature embeddings list, an importance of each set of attention weights from the plurality of attention weight sets. The heterogeneous multi-head self-attention layer may capture heterogeneous second-order feature interactions. For simplicity, the heterogeneous multi-head self-attention layer is referred to as “heterogeneous attention layer”, and the corresponding model as attention model module 444. In particular, the multi-head self-attention score computation for feature i and j of the feature embeddings may be redesigned as follows:

$$A t {t ( i , j )}^{h} = \frac{exp ( {ϕ}_{i , j}^{h} ( {e}_{i} , {e}_{j} ) )}{{\sum }_{m = 1}^{L} exp ( {ϕ}_{i , m}^{h} ( {e}_{i} , {e}_{m} ) )} \qquad ( 1 )$$

where h refers to the h-th head among total H heads, L is the embedding list length,

$${ϕ}_{i , j}^{h} ( {e}_{i} , {e}_{j} )$$

measures semantic correlation between embedding eᵢ and eⱼ regarding head h.

The vanilla self-attention layer is referred to as the homogeneous attention layer. For every feature pair (i, j), there is a unique

$${ϕ}_{i , j}^{h} ( \cdot , \cdot )$$

to measure semantic correlation. In other words,

$${ϕ}_{i , j}^{h} ( \cdot , \cdot )$$

serves the purpose of selecting the most relevant information from eᵢ and eⱼ for the context of feature pair (i, j). Arbitrary functions may exist for

$${ϕ}_{i , j}^{h} ( \cdot , \cdot ) : [ {ℝ}^{d} , {ℝ}^{d} ] \to ℝ ,$$

such as some explicit non-additive functions or a neural network with nonlinear transformation. For simplicity, the dot-product function can be used. Accordingly,

$${ϕ}_{i , j}^{h} ( {e}_{i} , {e}_{j} ) = \frac{{e}_{i} {{Q}_{i}^{h} ( {e}_{j} {K}_{j}^{h} )}^{T}}{\sqrt{{d}_{k}}} \qquad ( 2 )$$

where Qᵢ ∈ [symbol] ^{d×d}^{ₖ}, Kᵢ ∈ [symbol] ^{d}^{ₖ}^{×d} are query and key projections for feature j and j, respectively, and \sqrt{dₖ} is to normalize magnitude of the dot product, which is often set to be dₖ=d/H. With the attention weights computed in Eq (1), the output of the heterogeneous attention layer is computed as follows:

$${o}_{i} = c o n c a t ( {\{ {\sum }_{j} {Att ( i , j )}^{h} {e}_{j} {V}_{j}^{h} \}}_{h = 1}^{H} ) {O}_{j} \qquad ( 3 )$$

where Vⱼ ∈ [symbol] ^{d×d}^{ᵥ}, Oⱼ ∈ [symbol] ^{d}^{ᵥ}^{×d} are value and output projections, and do is frequently set as dᵥ=d/H. Similar to the heterogeneous attention layer, a heterogeneous fully connected Feed Forward Network (FFN) may be designed per feature. The FFN may be implemented through two linear transformation functions with Gaussian Error Linear Unit (GELU) activation:

$${FFN}_{GELU}^{i} ( {o}_{i} ) = GELU ( {o}_{i} {W}_{1}^{i} + {b}_{1}^{i} ) {W}_{2}^{i} + {b}_{2}^{i} \qquad ( 4 )$$

where

$${W}_{1}^{i} ∈ {ℝ}^{d \times {d}_{f}} , {W}_{2}^{i} ∈ {ℝ}^{{d}_{f} \times d} , {b}_{1}^{i} ∈ {ℝ}^{{d}_{f}} , {b}_{2}^{i} ∈ {ℝ}^{d} ,$$

and d_{f} is the layer size of the intermediate layer. d_{f} is set as d_{f}=4d, where d is the dimensionality of model. By applying a heterogeneous fully connected FFN to each feature in the feature embeddings list, attention model module 444 may learn complex, nonlinear interactions between the different features.

The key change of the heterogeneous attention layer, compared with a homogenous attention layer, is that attention model module 444 learns individual query, key, and value (QKV) projection matrices (i.e., Q, K, V) per feature. Therefore, the number of parameters in the heterogeneous attention layer is increased, as compared with the vanilla transformer model. The number of parameters scales linearly with the length of input feature embeddings list. However, it is worth noting that the total number of floating point operations per second are the same for the heterogeneous attention layer and homogeneous attention layer (the standard multi-head self-attention layer in the Transformer). This is because there are the exact same operations compared with homogeneous Transformer layer, but with different parameterizations.

Equation 2 can be written as:

$${ϕ}_{i , j}^{h} ( {e}_{i} , {e}_{j} ) = \frac{{e}_{i} {{Q}_{i}^{h} ( {K}_{j}^{h} )}^{T} {e}_{j}^{T}}{\sqrt{{d}_{k}}} = \frac{{e}_{i} {M}_{i , j}^{h} {e}_{j}^{T}}{\sqrt{{d}_{k}}} \qquad ( 5 )$$

where

$${M}_{i , j}^{h} = {{Q}_{i}^{h} ( {K}_{j}^{h} )}^{T} .$$

Hence, the heterogeneous attention layer can be interpreted as learning a unique transformation matrix regarding every feature pair (eᵢ, eⱼ), such that

$${M}_{i , j}^{h}$$

transforms the embeddings of eᵢ, eⱼ, and selects the most relevant information for interaction learning. Specifically, with respect to FIG. 4, transformation matrix generation module 446 may be configured to retrieve the feature embeddings list from feature embeddings storage 342. Transformation matrix generation module 446 may be further configured to generate a unique transformation matrix for each pair of feature embeddings included in the feature embeddings list. More specifically, transformation matrix generation module 446 may be configured to generate a unique transformation matrix for each pair of feature embeddings, wherein the unique transformation matrix transforms each individual feature embedding into a shared space for further matrix operations.

$$As {ϕ}_{i , j}^{h} ( \cdot , \cdot )$$

has a different transformation matrix

$${M}_{i , j}^{h} , {ϕ}_{i , j}^{h} ( \cdot , \cdot )$$

therefore captures heterogeneous second-order feature interaction between feature i and j. It should be noted that

$${M}_{i , j}^{h} \neq {M}_{j , i}^{h} , ,$$

meaning that the interaction learning function

$${ϕ}_{i , j}^{h} ( \cdot , \cdot )$$

is asymmetric. If

$${M}_{i , j}^{h}$$

are the same for all i, j's, the heterogeneous attention layer is reduced to the homogeneous attention layer.

The attention pattern learned with a vanilla transformer model may be relatively sparse and exhibit a strong diagonal pattern, indicating that the attention layer might not effectively capture the collaborative effects between different features. Alternatively, for the heterogeneous attention layer, there is a dense attention pattern.

In sequence modeling, position encoding is frequently applied to describe the position of an entity in a sequence so that each position is assigned a unique representation. However, a simple feature encoding cannot be learned for heterogeneous feature interaction learning. In position encoding, the embedding of each position is learned through an embedding lookup table. Applying position encoding is equivalent to adding a bias term for each embedding lookup table, which can be easily offset during the embedding lookup table learning. In other words, the position encoding is additive, which is not sufficient to capture the heterogeneous feature interactions. However, in the heterogeneous attention layer, there is transformation matrix

$${M}_{i , j}^{h} .$$

The transformation is non-additive and has more model expressiveness to capture the most relevant collaborative effects from the dynamic feature embeddings.

Attention model module 444 may further apply low-rank approximation to the individual query, key, and value projection matrices. In this way, the computation cost may be reduced for the individual query, key, and value projections, and the serving latency of heterogenous interaction transformer model module 450 may be reduced without compromising model quality. Additionally, the application of low-rank approximation by attention model module 444 may further reduce inference cost for online deployment.

Responsive to attention model module 444 learning the individual query, key, and value projection matrices for each individual feature embedding in each pair of feature embeddings, attention model module 444 may then send the feature embeddings and individual query, key, and value projection matrices to full projection matrix module 448. Full projection matrix module 448 may concatenate the individual query, key, and value projection matrices for each individual feature embedding into a single concatenated matrix. Full projection matrix module 448 may then generate a full projection matrix by at least applying a linear transformation to the single concatenated matrix.

For example, with the heterogeneous attention layer of attention model module 444, there are individual query, key, and value projection matrices per embedding in the feature embeddings list. The feature embeddings list is then rearranged to a concatenated embedding, and the individual query, key, and value projection matrices may be rearranged accordingly. All of the individual query, key, and value projection matrices may form a block-diagonal matrix. As such, the constraint on the individual query, key, and value projection matrices being a block-diagonal matrix may be relaxed, and a full projection matrix may be learned. As a result, the individual query, key, and value projections have much more expressiveness than a block-diagonal projection matrix. The model expressiveness is then further increased through the full matrix projection with heterogenous interaction transformer model module 450.

Heterogenous interaction transformer model module 450 may receive the unique transformation matrices for each pair of feature embeddings from transformation matrix generation module 446. Heterogenous interaction transformer model module 450 may also receive the full projection matrix from full projection matrix module 448. Heterogenous interaction transformer model module 450 may also receive the feature embeddings list from feature embeddings storage 342. Heterogenous interaction transformer model module 450 may also receive the encoded task embeddings list from feature embeddings storage 342 or user-item interaction storage 220. Using the full projection matrix, heterogeneous interaction transformer model module 450 may apply a heterogeneous interaction transformer model to the feature embeddings list and the encoded task embeddings list, wherein the feature embeddings list is transformed into a plurality of composite features. The heterogeneous interaction transformer model may then compute attention scores between the encoded task embeddings list and the plurality of composite features. The attention scores may then be used to generate a weighted feature embeddings list including weighted categorical features, weighted dense scalar features, and weighted task embeddings.

Mathematically, instead of learning feature interactions explicitly with feature pairs, the feature embeddings list may first be transformed into composite features as keys and values. The heterogeneous interaction transformer model comprises a heterogeneous interaction transformer attention layer, wherein the encoded task embeddings are used as queries for the heterogeneous interaction transformer attention layer, and wherein the plurality of composite features is used as keys and values for the heterogeneous interaction transformer attention layer. Heterogenous interaction transformer model module 450 may only comprise a one-layer model that learns heterogeneous feature interaction between these composite features and encoded task embeddings. With the full matrix projection for QKV, the i-th embeddings of h-th head can be rewritten for query, key, and value, respectively, in the heterogeneous feature interaction transformer model attention layer as follows:

$${q}_{i}^{h} = {\sum }_{l}^{L} {e}_{l} {Q}_{l , i}^{h} , {k}_{i}^{h} = {\sum }_{l}^{L} {e}_{l} {K}_{l , i}^{h} , {v}_{i}^{h} = {\sum }_{l}^{L} {e}_{l} {V}_{l , i}^{h}$$

where

$${Q}_{l , i}^{h} ∈ {ℝ}^{d \times {d}_{k}} , {K}_{l , i}^{h} ∈ {ℝ}^{d \times {d}_{k}} , {V}_{l , i}^{h} ∈ {ℝ}^{d \times {d}_{v}} , ( ∀ l , i = \{ 1 , … , L \} )$$

are the query, key, and value projection matrices accordingly. Note that the notation of Q, K, V has been overridden, which is also used above but with different definitions. Following the heterogeneous attention layer in Eq (1), heterogeneous feature interaction transformer model 450 computes the attention scores between the query qᵢ and key kᵢ as follows:

$$A t {{t}_{C R O S S} ( i , j )}^{h} = \frac{exp ( \frac{{{q}_{i}^{h} ( {k}_{i}^{h} )}^{T}}{\sqrt{{d}_{k}}} )}{{Σ}_{l}^{L} exp ( \frac{{{q}_{i}^{h} ( {k}_{l}^{h} )}^{T}}{\sqrt{{d}_{k}}} )} \qquad ( 6 )$$

With the attention scores, the output of the attention layer in the heterogeneous interaction transformer model module 450 can then be computed as:

$${o}_{i} = c o n c a t ( {\{ {\sum }_{m} A t {t}_{CROSS}^{h} ( i , j ) {v}^{h} \}}_{h = 1}^{H} ) {O}_{j} \qquad ( 7 )$$

In essence, the attention scores calculated by heterogenous interaction transformer model module 450 may be used to generate a weighted feature embeddings list including weighted categorical features, weighted dense scalar features, and weighted task embeddings. Heterogenous interaction transformer model module 450 may then send the weighted feature embeddings list to projection function module 452 to generate a final predicted output.

Projection function module 452 may receive the weighted task embeddings from heterogeneous interaction transformer model module 450. Responsive to receiving the weighted task embeddings, projection function module 452 may further transform the weighted task embeddings into a final predicted output, wherein the final predicted output is a set of recommended items that a user of computing device 212 will likely interact with. Projection function module 452 may comprise a machine-learned model such as a DNN. In some examples, projection function matrix module 448 may apply a multi-layer perceptron (MLLP) tower that is trained to project the encoded task embeddings to the final predicted output. In some examples, the training tasks can be flexibly configured based on the recommendation application. For example, the training task can be a classification task if the labels are click or installation. In some examples, the training task may also be a regression task, such as in the case of watch time. In some examples, such as the task of installation, the labels are binary, with a value of 0 indicating non-installation and 1 indicating installation. Thus, the training objective can be formulated as a binary classification problem with the Binary Cross Entropy (i.e., Log Loss):

$$ℓ = \frac{1}{N} {\sum }_{i}^{N} - {y}_{i} log ( {p}_{i} ) - ( 1 - {y}_{i} ) log ( 1 - {p}_{i} )$$

where yᵢ and pᵢ are the ground truth label and predicted probability of engagements for example i, respectively, and N is the total number of training examples.

Projection function module 452 may then send the final predicted output, which may include data indicative of the set of recommended items that the user is likely to interact with, to recommended items storage 236 of FIG. 2. In general, recommended items storage 236 may be configured as a database, flat file, table, or other data structure stored within computing system 200. In some examples, recommended items storage 236 is shared between various modules executing at computing system 100. In other examples, a different data repository is configured for a module executing at computing system 200 that requires a data repository.

As described herein, the final predicted output data stored in recommended items storage 236 may be used by recommendation module 208 to generate a set of recommendations to a user of computing device 212. For example, recommendation module 208 may retrieve the final predicted output data from recommended items storage 236 and then generate a set of recommendations that may be sent to and presented to a user of computing device 212 via user interface device 202.

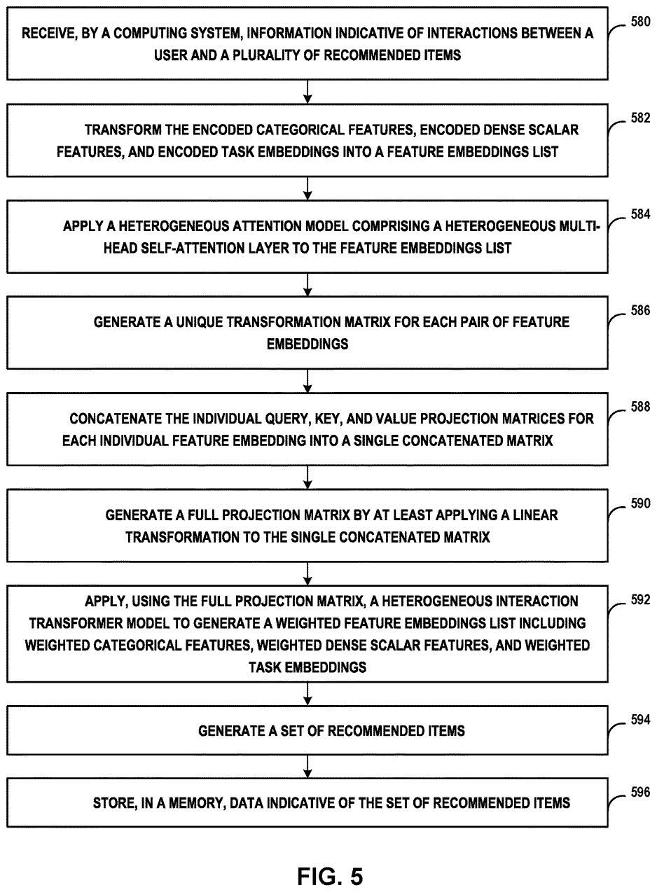

FIG. 5 is a flowchart illustrating an example operation for applying a heterogeneous feature interaction transformer model, in accordance with one or more techniques of this disclosure. The components of FIG. 5 are described with respect to FIGS. 1-4. Computing system 200 receives, from computing device 212, receive information indicative of interactions between a user and a plurality of previously recommended items, wherein the information includes one or more of encoded categorical features of one or more user-item pairs, encoded dense scalar features of one or more user-item pairs, and encoded task embeddings (580). The plurality of previously recommended items may be provided by recommendation module 208. Computing system 200 may store the information in user-item interaction storage 220. Preprocessing module 332 may then retrieve the information from user-item interaction storage 220, in which computing system 200, and more specifically feature transformation module 340, transforms the encoded categorical features, encoded dense scalar features, and encoded task embeddings into a feature embeddings list, wherein the feature embeddings list includes pairs of feature embeddings (582). The feature embeddings list may be stored in feature embeddings storage 342. Machine learning module 410 may then retrieve the feature embeddings list from feature embeddings storage 342. Computing system 200 then applies a heterogeneous attention model comprising a heterogeneous multi-head self-attention layer to the feature embeddings list, wherein the heterogeneous self-attention model learns individual query, key, and value projection matrices for each individual feature embedding in each pair of feature embeddings (584). Computing system 200, and more specifically transformation matrix generation module 446, generates a unique transformation matrix for each pair of feature embeddings, wherein the unique transformation matrix transforms each individual feature embedding into a shared space (586). Computing system 200, and more specifically full projection matrix module 448, concatenates the individual query, key, and value projection matrices for each individual feature embedding into a single concatenated matrix (588). Computing system 200, and more specifically full projection matrix module 448, then generates a full projection matrix by at least applying a linear transformation to the single concatenated matrix (590). Computing system 200, and more specifically heterogeneous interaction transformer model module 450, then applies, using the full projection matrix, a heterogeneous interaction transformer model to the feature embeddings list and the encoded task embeddings, wherein the feature embeddings list is transformed into a plurality of composite features, wherein the heterogeneous interaction transformer model computes attention scores between the encoded task embeddings and the plurality of composite features, and wherein the attention scores are used to generate a weighted feature embeddings list including weighted categorical features, weighted dense scalar features, and weighted task embeddings (592). Computing system 200, and more specifically projection function module 452 generates a set of recommended items based on applying a projection function to the weighted task embeddings, wherein the projection function transforms the weighted task embeddings into the set of recommended items (594). Computing system 200 then stores, in storage device 238, and more specifically recommended items storage 236, data indicative of the set of recommended items (596). The data indicative of the set of recommended items may be used by recommendation module 208 to generate recommendations to a user of computing device 212 for display via user interface device 202.

This disclosure includes various examples, such as the following examples:
Example 1. A method comprising: receiving, by a computing system, information indicative of interactions between a user and a plurality of previously recommended items, wherein the information includes one or more of encoded categorical features of one or more user-item pairs, encoded dense scalar features of one or more user-item pairs, and encoded task embeddings; transforming, by the computing system, one or more of the encoded categorical features, the encoded dense scalar features, and the encoded task embeddings into a feature embeddings list, wherein the feature embeddings list includes pairs of feature embeddings; applying, by the computing system, a heterogeneous self-attention model comprising a heterogeneous multi-head self-attention layer to the feature embeddings list, wherein the heterogeneous self-attention model learns individual query, key, and value projection matrices for each individual feature embedding in each pair of feature embeddings; generating, by the computing system, a unique transformation matrix for each pair of feature embeddings, wherein the unique transformation matrix transforms each individual feature embedding into a shared space; concatenating, by the computing system, the individual query, key, and value projection matrices for each individual feature embedding into a single concatenated matrix; generating, by the computing system, a full projection matrix by at least applying a linear transformation to the single concatenated matrix; applying, by the computing system, and using the full projection matrix, a heterogeneous interaction transformer model to the feature embeddings list and the encoded task embeddings, wherein the feature embeddings list is transformed into a plurality of composite features, wherein the heterogeneous interaction transformer model computes attention scores between the encoded task embeddings and the plurality of composite features, and wherein the attention scores are used to generate a weighted feature embeddings list including weighted categorical features, weighted dense scalar features, and weighted task embeddings; generating, by the computing system, a set of recommended items based on applying a projection function to the weighted task embeddings, wherein the projection function transforms the weighted task embeddings into the set of recommended items; and storing, by the computing system, in a memory, data indicative of the set of recommended items.
Example 2. The method of example 1, wherein the heterogeneous multi-head self-attention layer further comprises: a plurality of attention weight sets, wherein each attention weight set from the plurality of attention weight sets corresponds to a subset of the feature embeddings list that includes pairs of feature embeddings; and a weighting function that determines, based on the feature embeddings list, an importance of each set of attention weights from the plurality of attention weight sets.
Example 3. The method of example 2, wherein the pairs of feature embeddings include at least one user embedding and at least one item embedding.
Example 4. The method of any of examples 1-3, wherein the heterogeneous self-attention model further comprises applying a heterogeneous fully connected Feed Forward Network to each feature in the feature embeddings list.
Example 5. The method of any of examples 1-4, wherein the heterogeneous interaction transformer model comprises a heterogeneous interaction transformer attention layer, wherein the encoded task embeddings are used as queries for the heterogeneous interaction transformer attention layer, and wherein the plurality of composite features is used as keys and values for the heterogeneous interaction transformer attention layer.
Example 6. The method of any of examples 1-5, wherein applying the heterogeneous self-attention model further comprises applying low-rank approximation to the individual query, key, and value projection matrices.
Example 7. The method of any of examples 1-6, wherein the heterogeneous interaction transformer model is a one-layer model.
Example 8. A computing system comprising: one or more processors; and one or more storage devices that store instructions, wherein the instructions, when executed by the one or more processors, cause the one or more processors to: receive information indicative of interactions between a user and a plurality of previously recommended items, wherein the information includes one or more of encoded categorical features of one or more user-item pairs, encoded dense scalar features of one or more user-item pairs, and encoded task embeddings; transform one or more of the encoded categorical features, the encoded dense scalar features, and the encoded task embeddings into a feature embeddings list, wherein the feature embeddings list includes pairs of feature embeddings; apply a heterogeneous self-attention model comprising a heterogeneous multi-head self-attention layer to the feature embeddings list, wherein the heterogeneous self-attention model learns individual query, key, and value projection matrices for each individual feature embedding in each pair of feature embeddings; generate a unique transformation matrix for each pair of feature embeddings, wherein the unique transformation matrix transforms each individual feature embedding into a shared space; concatenate the individual query, key, and value projection matrices for each individual feature embedding into a single concatenated matrix; generate a full projection matrix by at least applying a linear transformation to the single concatenated matrix; apply, using the full projection matrix, a heterogeneous interaction transformer model to the feature embeddings list and the encoded task embeddings, wherein the feature embeddings list is transformed into a plurality of composite features, wherein the heterogeneous interaction transformer model computes attention scores between the encoded task embeddings and the plurality of composite features, and wherein the attention scores are used to generate a weighted feature embeddings list including weighted categorical features, weighted dense scalar features, and weighted task embeddings; generate a set of recommended items based on applying a projection function to the weighted task embeddings, wherein the projection function transforms the weighted task embeddings into the set of recommended items; and store data indicative of the set of recommended items in the one or more storage devices.
Example 9. The computing system of example 8, wherein the heterogeneous multi-head self-attention layer further comprises: a plurality of attention weight sets, wherein each attention weight set from the plurality of attention weight sets corresponds to a subset of the feature embeddings list that includes pairs of feature embeddings; and a weighting function that determines, based on the feature embeddings list, an importance of each set of attention weights from the plurality of attention weight sets.
Example 10. The computing system of example 9, wherein the pairs of feature embeddings include at least one user embedding and at least one item embedding.
Example 11. The computing system of any of examples 8-10, wherein the heterogeneous self-attention model further comprises applying a heterogeneous fully connected Feed Forward Network to each feature in the feature embeddings list.
Example 12. The computing system of any of examples 8-11, wherein the heterogeneous interaction transformer model comprises a heterogeneous interaction transformer attention layer, wherein the encoded task embeddings are used as queries for the heterogeneous interaction transformer attention layer, and wherein the plurality of composite features is used as keys and values for the heterogeneous interaction transformer attention layer.
Example 13. The computing system of any of examples 8-12, wherein applying the heterogeneous self-attention model further comprises applying low-rank approximation to the individual query, key, and value projection matrices.
Example 14. The computing system of any of examples 8-13, wherein the heterogeneous interaction transformer model is a one-layer model.
Example 15. A non-transitory computer-readable storage medium encoded with instructions that, when executed by one or more processors, cause one or more processors to: receive information indicative of interactions between a user and a plurality of previously recommended items, wherein the information includes one or more of encoded categorical features of one or more user-item pairs, encoded dense scalar features of one or more user-item pairs, and encoded task embeddings; transform one or more of the encoded categorical features, the encoded dense scalar features, and the encoded task embeddings into a feature embeddings list, wherein the feature embeddings list includes pairs of feature embeddings; apply a heterogeneous self-attention model comprising a heterogeneous multi-head self-attention layer to the feature embeddings list, wherein the heterogeneous self-attention model learns individual query, key, and value projection matrices for each individual feature embedding in each pair of feature embeddings; generate a unique transformation matrix for each pair of feature embeddings, wherein the unique transformation matrix transforms each individual feature embedding into a shared space; concatenate the individual query, key, and value projection matrices for each individual feature embedding into a single concatenated matrix; generate a full projection matrix by at least applying a linear transformation to the single concatenated matrix; apply, using the full projection matrix, a heterogeneous interaction transformer model to the feature embeddings list and the encoded task embeddings, wherein the feature embeddings list is transformed into a plurality of composite features, wherein the heterogeneous interaction transformer model computes attention scores between the encoded task embeddings and the plurality of composite features, and wherein the attention scores are used to generate a weighted feature embeddings list including weighted categorical features, weighted dense scalar features, and weighted task embeddings; generate a set of recommended items based on applying a projection function to the weighted task embeddings, wherein the projection function transforms the weighted task embeddings into the set of recommended items; and store data indicative of the set of recommended items.
Example 16. The non-transitory computer-readable storage medium of example 15, wherein the heterogeneous multi-head self-attention layer further comprises: a plurality of attention weight sets, wherein each attention weight set from the plurality of attention weight sets corresponds to a subset of the feature embeddings list that includes pairs of feature embeddings; and a weighting function that determines, based on the feature embeddings list, an importance of each set of attention weights from the plurality of attention weight sets.
Example 17. The non-transitory computer-readable storage medium of example 16, wherein the pairs of feature embeddings include at least one user embedding and at least one item embedding.
Example 18. The non-transitory computer-readable storage medium of any of examples 15-17, wherein the heterogeneous self-attention model further comprises applying a heterogeneous fully connected Feed Forward Network to each feature in the feature embeddings list.
Example 19. The non-transitory computer-readable storage medium of any of examples 15-18, wherein the heterogeneous interaction transformer model comprises a heterogeneous interaction transformer attention layer, wherein the encoded task embeddings are used as queries for the heterogeneous interaction transformer attention layer, and wherein the plurality of composite features is used as keys and values for the heterogeneous interaction transformer attention layer.
Example 20. The non-transitory computer-readable storage medium of any of examples 15-19, wherein applying the heterogeneous self-attention model further comprises applying low-rank approximation to the individual query, key, and value projection matrices.
Example 21. The non-transitory computer-readable storage medium of any of examples 15-20, wherein the heterogeneous interaction transformer model is a one-layer model.
Example 22. A computer program product for a recommender system, the computer program product comprising at least one non-transitory computer-readable medium including one or more instructions that, when executed by at least one processor, cause the at least one processor to receive information indicative of interactions between a user and a plurality of previously recommended items, wherein the information includes one or more of encoded categorical features of one or more user-item pairs, encoded dense scalar features of one or more user-item pairs, and encoded task embeddings; transform one or more of the encoded categorical features, the encoded dense scalar features, and the encoded task embeddings into a feature embeddings list, wherein the feature embeddings list includes pairs of feature embeddings; apply a heterogeneous self-attention model comprising a heterogeneous multi-head self-attention layer to the feature embeddings list, wherein the heterogeneous self-attention model learns individual query, key, and value projection matrices for each individual feature embedding in each pair of feature embeddings; generate a unique transformation matrix for each pair of feature embeddings, wherein the unique transformation matrix transforms each individual feature embedding into a shared space; concatenate the individual query, key, and value projection matrices for each individual feature embedding into a single concatenated matrix; generate a full projection matrix by at least applying a linear transformation to the single concatenated matrix; apply, using the full projection matrix, a heterogeneous interaction transformer model to the feature embeddings list and the encoded task embeddings, wherein the feature embeddings list is transformed into a plurality of composite features, wherein the heterogeneous interaction transformer model computes attention scores between the encoded task embeddings and the plurality of composite features, and wherein the attention scores are used to generate a weighted feature embeddings list including weighted categorical features, weighted dense scalar features, and weighted task embeddings; generate a set of recommended items based on applying a projection function to the weighted task embeddings, wherein the projection function transforms the weighted task embeddings into the set of recommended items; and store data indicative of the set of recommended items.
Example 23. The computer program product of example 22, wherein the heterogeneous multi-head self-attention layer further comprises: a plurality of attention weight sets, wherein each attention weight set from the plurality of attention weight sets corresponds to a subset of the feature embeddings list that includes pairs of feature embeddings; and a weighting function that determines, based on the feature embeddings list, an importance of each set of attention weights from the plurality of attention weight sets.
Example 24. The computer program product of example 23, wherein the pairs of feature embeddings include at least one user embedding and at least one item embedding.
Example 25. The computer program product of any of examples 22-24, wherein the heterogeneous self-attention model further comprises applying a heterogeneous fully connected Feed Forward Network to each feature in the feature embeddings list.
Example 26. The computer program product of any of examples 22-25, wherein the heterogeneous interaction transformer model comprises a heterogeneous interaction transformer attention layer, wherein the encoded task embeddings are used as queries for the heterogeneous interaction transformer attention layer, and wherein the plurality of composite features is used as keys and values for the heterogeneous interaction transformer attention layer.
Example 27. The computer program product of any of examples 22-26, wherein applying the heterogeneous self-attention model further comprises applying low-rank approximation to the individual query, key, and value projection matrices.
Example 28. The computer program product of any of examples 22-27, wherein the heterogeneous interaction transformer model is a one-layer model.
Example 29. A computing system comprising means for performing any combination of the methods of examples 1-7.
Example 30. A computer-readable storage medium encoded with instructions for performing any combination of the methods of examples 1-7.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that may be accessed by one or more computers or one or more processors to retrieve instructions, code and/or data structures for implementation of the techniques described in this disclosure. A computer program product may include a computer-readable medium.

By way of example, and not limitation, such computer-readable storage media may comprise RAM, ROM, EEPROM, CD-ROM or other optical disk storage, magnetic disk storage, or other magnetic storage devices, flash memory, or any other storage medium that may be used to store desired program code in the form of instructions or data structures and that may be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of intraoperative hardware units, including one or more processors as described above, in conjunction with suitable software and/or firmware.

It is to be recognized that, depending on the example, certain acts or events of any of the techniques described herein may be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In some examples, a computer-readable storage medium comprises a non-transitory medium. The term “non-transitory” indicates that the storage medium is not embodied in a carrier wave or a propagated signal. In certain examples, a non-transitory storage medium may store data that can, over time, change (e.g., in RAM or cache).

Various examples have been described. These and other examples are within the scope of the following claims.

1. A method comprising:
receiving, by a computing system, information indicative of interactions between a user and a plurality of previously recommended items, wherein the information includes one or more of encoded categorical features of one or more user-item pairs, encoded dense scalar features of one or more user-item pairs, and encoded task embeddings;
transforming, by the computing system, one or more of the encoded categorical features, the encoded dense scalar features, and the encoded task embeddings into a feature embeddings list, wherein the feature embeddings list includes pairs of feature embeddings;
applying, by the computing system, a heterogeneous self-attention model comprising a heterogeneous multi-head self-attention layer to the feature embeddings list, wherein the heterogeneous self-attention model learns individual query, key, and value projection matrices for each individual feature embedding in each pair of feature embeddings;
generating, by the computing system, a unique transformation matrix for each pair of feature embeddings, wherein the unique transformation matrix transforms each individual feature embedding into a shared space;
concatenating, by the computing system, the individual query, key, and value projection matrices for each individual feature embedding into a single concatenated matrix;
generating, by the computing system, a full projection matrix by at least applying a linear transformation to the single concatenated matrix;
applying, by the computing system, and using the full projection matrix, a heterogeneous interaction transformer model to the feature embeddings list and the encoded task embeddings, wherein the feature embeddings list is transformed into a plurality of composite features, wherein the heterogeneous interaction transformer model computes attention scores between the encoded task embeddings and the plurality of composite features, and wherein the attention scores are used to generate a weighted feature embeddings list including weighted categorical features, weighted dense scalar features, and weighted task embeddings;
generating, by the computing system, a set of recommended items based on applying a projection function to the weighted task embeddings, wherein the projection function transforms the weighted task embeddings into the set of recommended items; and
storing, by the computing system, in a memory, data indicative of the set of recommended items.

2. The method of claim 1, wherein the heterogeneous multi-head self-attention layer further comprises:
a plurality of attention weight sets, wherein each attention weight set from the plurality of attention weight sets corresponds to a subset of the feature embeddings list that includes pairs of feature embeddings, and
a weighting function that determines, based on the feature embeddings list, an importance of each set of attention weights from the plurality of attention weight sets.

3. The method of claim 2, wherein the pairs of feature embeddings include at least one user embedding and at least one item embedding.

4. The method of claim 1, wherein applying the heterogeneous self-attention model further comprises applying a heterogeneous fully connected Feed Forward Network to each feature in the feature embeddings list.

5. The method of claim 1, wherein the heterogeneous interaction transformer model comprises a heterogeneous interaction transformer attention layer, wherein the encoded task embeddings are used as queries for the heterogeneous interaction transformer attention layer, and wherein the plurality of composite features is used as keys and values for the heterogeneous interaction transformer attention layer.

6. The method of claim 1, wherein applying the heterogeneous self-attention model further comprises applying low-rank approximation to the individual query, key, and value projection matrices.

7. The method of claim 1, wherein the heterogeneous interaction transformer model is a one-layer model.

8. A computing system comprising:
one or more processors; and
one or more storage devices that store instructions, wherein the instructions, when executed by the one or more processors, cause the one or more processors to:
receive information indicative of interactions between a user and a plurality of previously recommended items, wherein the information includes one or more of encoded categorical features of one or more user-item pairs, encoded dense scalar features of one or more user-item pairs, and encoded task embeddings;
transform one or more of the encoded categorical features, the encoded dense scalar features, and the encoded task embeddings into a feature embeddings list, wherein the feature embeddings list includes pairs of feature embeddings;
apply a heterogeneous self-attention model comprising a heterogeneous multi-head self-attention layer to the feature embeddings list, wherein the heterogeneous self-attention model learns individual query, key, and value projection matrices for each individual feature embedding in each pair of feature embeddings;
generate a unique transformation matrix for each pair of feature embeddings, wherein the unique transformation matrix transforms each individual feature embedding into a shared space;
concatenate the individual query, key, and value projection matrices for each individual feature embedding into a single concatenated matrix;
generate a full projection matrix by at least applying a linear transformation to the single concatenated matrix;
apply, using the full projection matrix, a heterogeneous interaction transformer model to the feature embeddings list and the encoded task embeddings, wherein the feature embeddings list is transformed into a plurality of composite features, wherein the heterogeneous interaction transformer model computes attention scores between the encoded task embeddings and the plurality of composite features, and wherein the attention scores are used to generate a weighted feature embeddings list including weighted categorical features, weighted dense scalar features, and weighted task embeddings;
generate a set of recommended items based on applying a projection function to the weighted task embeddings, wherein the projection function transforms the weighted task embeddings into the set of recommended items; and
store data indicative of the set of recommended items in the one or more storage devices.

9. The computing system of claim 8, wherein the heterogeneous multi-head self-attention layer further comprises:
a plurality of attention weight sets, wherein each attention weight set from the plurality of attention weight sets corresponds to a subset of the feature embeddings list that includes pairs of feature embeddings, and
a weighting function that determines, based on the feature embeddings list, an importance of each set of attention weights from the plurality of attention weight sets.

10. The computing system of claim 9, wherein the pairs of feature embeddings include at least one user embedding and at least one item embedding.

11. The computing system of claim 8, wherein to apply the heterogeneous self-attention model, the instructions further cause the one or more processors to apply a heterogeneous fully connected Feed Forward Network to each feature in the feature embeddings list.

12. The computing system of claim 8, wherein the heterogeneous interaction transformer model is a one-layer model comprising a heterogeneous interaction transformer attention layer, wherein the encoded task embeddings are used as queries for the heterogeneous interaction transformer attention layer, and wherein the plurality of composite features is used as keys and values for the heterogeneous interaction transformer attention layer.

13. The computing system of claim 8, wherein to apply the heterogeneous self-attention model, the instructions further cause the one or more processors to apply low-rank approximation to the individual query, key, and value projection matrices.

14. (canceled)

15. (canceled)

16. A non-transitory computer-readable storage medium encoded with instructions that, when executed by one or more processors, cause one or more processors to:
receive information indicative of interactions between a user and a plurality of previously recommended items, wherein the information includes one or more of encoded categorical features of one or more user-item pairs, encoded dense scalar features of one or more user-item pairs, and encoded task embeddings;
transform one or more of the encoded categorical features, the encoded dense scalar features, and the encoded task embeddings into a feature embeddings list, wherein the feature embeddings list includes pairs of feature embeddings;
apply a heterogeneous self-attention model comprising a heterogeneous multi-head self-attention layer to the feature embeddings list, wherein the heterogeneous self-attention model learns individual query, key, and value projection matrices for each individual feature embedding in each pair of feature embeddings;
generate a unique transformation matrix for each pair of feature embeddings, wherein the unique transformation matrix transforms each individual feature embedding into a shared space;
concatenate the individual query, key, and value projection matrices for each individual feature embedding into a single concatenated matrix;
generate a full projection matrix by at least applying a linear transformation to the single concatenated matrix;
apply, using the full projection matrix, a heterogeneous interaction transformer model to the feature embeddings list and the encoded task embeddings, wherein the feature embeddings list is transformed into a plurality of composite features, wherein the heterogeneous interaction transformer model computes attention scores between the encoded task embeddings and the plurality of composite features, and wherein the attention scores are used to generate a weighted feature embeddings list including weighted categorical features, weighted dense scalar features, and weighted task embeddings;
generate a set of recommended items based on applying a projection function to the weighted task embeddings, wherein the projection function transforms the weighted task embeddings into the set of recommended items; and
store data indicative of the set of recommended items in one or more storage devices.

17. The non-transitory computer-readable storage medium of claim 16, wherein the heterogeneous multi-head self-attention layer further comprises:
a plurality of attention weight sets, wherein each attention weight set from the plurality of attention weight sets corresponds to a subset of the feature embeddings list that includes pairs of feature embeddings, and
a weighting function that determines, based on the feature embeddings list, an importance of each set of attention weights from the plurality of attention weight sets.

18. The non-transitory computer-readable storage medium of claim 17, wherein the pairs of feature embeddings include at least one user embedding and at least one item embedding.

19. The non-transitory computer-readable storage medium of claim 16, wherein to apply the heterogeneous self-attention model, the instructions further cause the one or more processors to apply a heterogeneous fully connected Feed Forward Network to each feature in the feature embeddings list.

20. The non-transitory computer-readable storage medium of claim 16, wherein the heterogeneous interaction transformer model comprises a heterogeneous interaction transformer attention layer, wherein the encoded task embeddings are used as queries for the heterogeneous interaction transformer attention layer, and wherein the plurality of composite features is used as keys and values for the heterogeneous interaction transformer attention layer.

21. The non-transitory computer-readable storage medium of claim 16, wherein to apply the heterogeneous self-attention model, the instructions further cause the one or more processors to apply low-rank approximation to the individual query, key, and value projection matrices.

22. The non-transitory computer-readable storage medium of claim 16, wherein the heterogeneous interaction transformer model is a one-layer model.
